(19) United States
(12) Patent Application Publication
(10) Pub. No.: US 2012/0061633 A1
(43) Pub. Date: Mar. 15, 2012

(54) CABLE PULLING MACHINE

(76) Inventor: DONALD HOLLEY, Wylie, TX (US)

(21) Appl. No.: 13/210,290

(22) Filed: Aug. 15, 2011

Related U.S. Application Data
(63) Continuation-in-part of application No. 12/794,469, filed on Jun. 4, 2010.
(60) Provisional application No. 61/184,185, filed on Jun. 4, 2009.
(60) Provisional application No. 61/373,389, filed on Aug. 13, 2010.

(51) Int. Cl. H02G 1/06

(52) U.S. Cl. 254/134.3 R

(57) ABSTRACT

An embodiment of a handheld portable cable puller for pulling cable through a raceway includes a housing, a spool fixedly interfaced to the housing. and a length of pulling cable disposed on the spool for being played out from the spool and rewound on the spool. The handheld portable cable puller further includes a motive device for driving the spool to rewind the pulling cable on the spool, and an interface for abutting proximate to an end of the raceway to substantially absorb resistive forces from the pulling cable during rewinding. The handheld portable cable puller further includes a processor; and a memory coupled to the processor.

### CROSS-REFERENCE TO RELATED APPLICATIONS

This application is a continuation-in-part of U.S. patent application Ser. No. 12/794,469, filed Jun. 4, 2010, entitled CABLE PULLING MACHINE (Atty. Dkt. No. HOLL-29,750) which claims benefit of U.S. Provisional Application No. 61/184,185, filed Jun. 4, 2009, entitled CABLE PULLING MACHINE (Atty. Dkt. No. HOLL-29,483), the specifications of which are incorporated herein by reference, and this application also claims benefit to U.S. Provisional Application No. 61/373,389, filed Aug. 13, 2010, entitled CABLE PULLING MACHINE (Atty. Dkt. No. 30,333), the specification of which is incorporated herein by reference.

### TECHNICAL FIELD

Embodiments of the invention relate to a device for pulling cables or wires, and more particularly, to a handheld cable puller for pulling cables or wires through a raceway or conduit.

### BACKGROUND

To accomplish the distribution of electricity, insulated electrical wire must be installed between the power source and power distribution box and routed to electrical boxes to supply the required electrical power to a device, such as an electrical outlet, lighting fixture or raceways. In many instances, electrical wires in buildings are routed through one or more conduits to connect electrical boxes and/or panels together. Conduits often span great distances and may include one or more elbows or turns. This increases the difficulty of pulling wires through the conduits. In many instances, the conduit is hidden behind walls and above the ceilings in buildings. A typical method of pulling cable through conduit requires multiple workers arduously pulling lengths of cable through the conduit by hand, which can be a time consuming and manual labor intensive process.

### SUMMARY

An embodiment of a handheld portable cable puller for pulling cable through a raceway includes a housing, a spool fixedly interfaced to the housing. and a length of pulling cable disposed on the spool for being played out from the spool and rewound on the spool. The handheld portable cable puller further includes a motive device for driving the spool to rewind the pulling cable on the spool, and an interface for abutting proximate to an end of the raceway to substantially absorb resistive forces from the pulling cable during rewinding. The handheld portable cable puller further includes a processor; and a memory coupled to the processor. The processor is configured to receive data including a designation of a specified maximum pulling force associated with a particular cable, measure an actual pulling force during a pulling operation of the particular cable, stop the motive device if the measured actual pulling force exceeds the specified maximum pulling force.

### BRIEF DESCRIPTION OF THE DRAWINGS

For a more complete understanding, reference is now made to the following description taken in conjunction with the accompanying Drawings in which:

FIGS. 1A-1U illustrate an embodiment of a handheld cable puller;

FIG. 1V-1W illustrate another embodiment of the handheld cable puller;

FIG. 1X illustrates a right-rear perspective view of still another embodiment of the handheld cable puller;

FIG. 1Y illustrates another embodiment of the cable drum having a hook for attaching a jetline;

FIG. 2 illustrates an embodiment of a wiring diagram of the handheld cable puller;

FIGS. 3A-3B illustrate an embodiment of the pulling arm and pulling head of the handheld cable puller of FIG. 1A-1T;

FIGS. 4A-4B illustrate an embodiment of an extension bar;

FIGS. 4C-4D illustrate another embodiment of the extension bar;

FIG. 5 illustrates a perspective view of another embodiment of the pulling arm and extension bar;

FIG. 6 illustrates an example operation of the handheld cable puller;

FIG. 7 illustrates a perspective view of an embodiment of the funnel system, raceway, and rotating flexible feed end of FIG. 6;

FIGS. 8A-8B illustrate an embodiment of the box roller of FIG. 6;

FIGS. 9A & 9B illustrate an alternative embodiment of a pulling arm;

FIGS. 10A-10B illustrate another alternative embodiment of a pulling arm;

FIG. 11 illustrates another embodiment of a pulling arm;

FIG. 12 illustrates an embodiment of a cable head for attachment of cables or wires to the pulling cable;

FIGS. 13A-13B illustrate an embodiment of a hand-held cable puller having a configurable maximum pulling force;

FIG. 14 illustrates a block diagram of the electronic control module of the hand-held cable puller of FIGS. 13A-13B;

FIG. 15 illustrates an embodiment of a procedure for operation of the hand-held cable puller of FIGS. 13A-13B;

FIGS. 16A-16B illustrates an example of a blueprint table stored within a memory of the hand-held cable puller of FIGS. 13A-13B;

FIGS. 17A-17B illustrate an alternative embodiment of a pulling force measurement arrangement of the hand-held cable puller of FIGS. 13A-13B;

FIGS. 18A-18B illustrate another embodiment of a pulling force measurement arrangement for the hand-held cable puller of FIGS. 13A-13B;

FIG. 19 illustrates an embodiment of a hand-held cable puller having a rear mounted load cell to measure pulling force exerted on a pulled cable; and

FIG. 20 illustrates still another embodiment of a hand-held cable puller having a frontally mounted load cell to measure pulling force exerted on a pull cable.

### DETAILED DESCRIPTION

Referring now to the drawings, wherein like reference numbers are used herein to designate like elements throughout, the various views and embodiments of a cable pulling machine are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

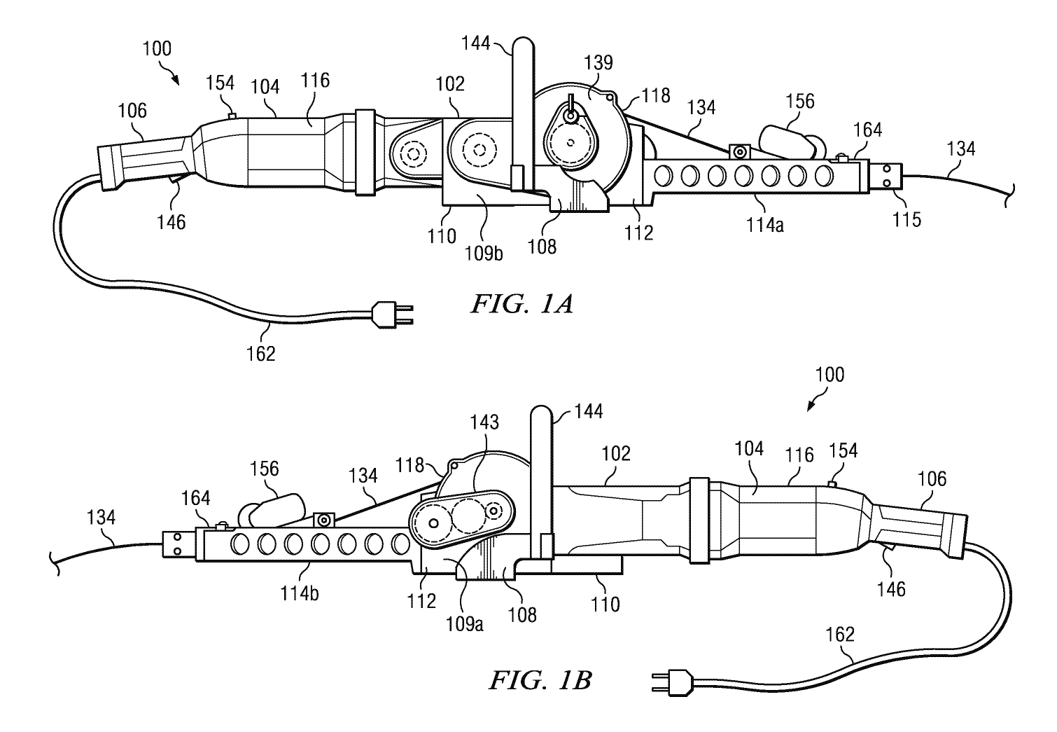

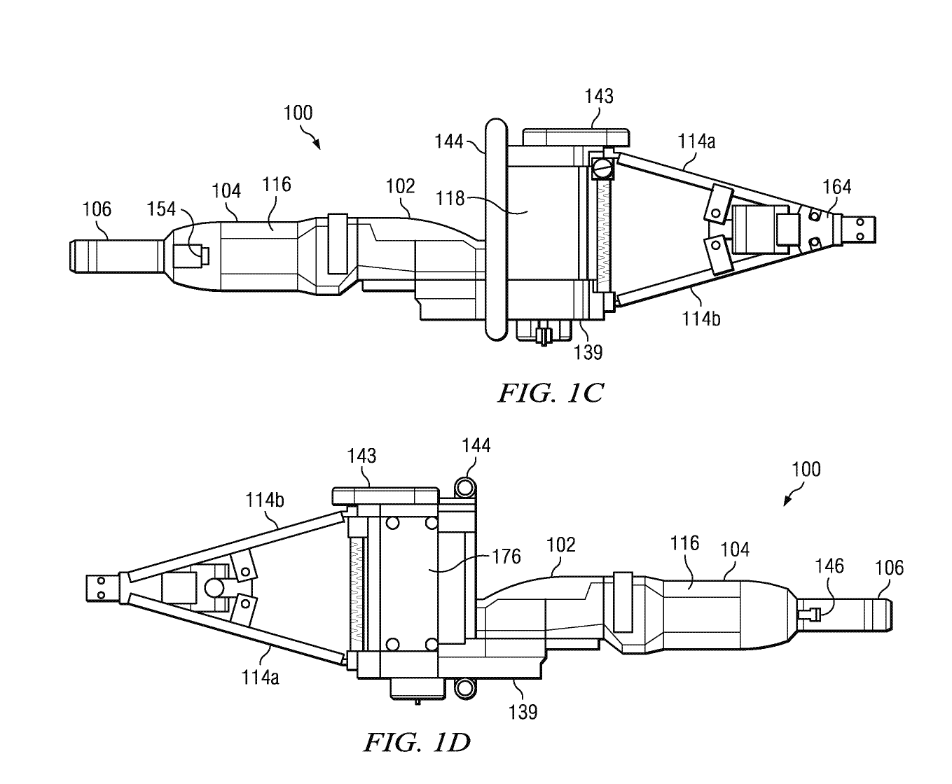

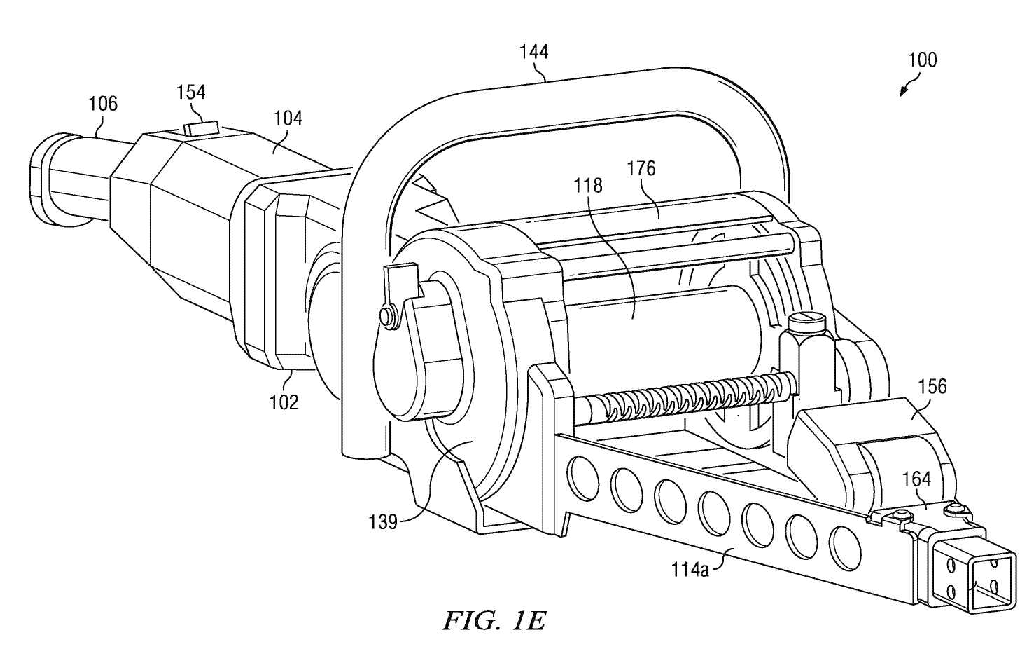

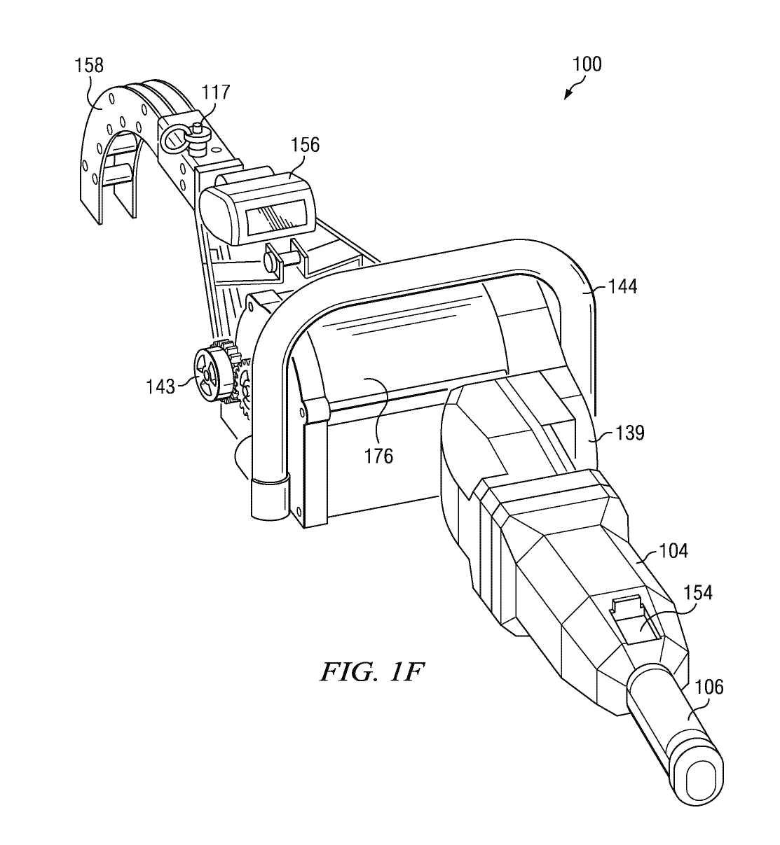

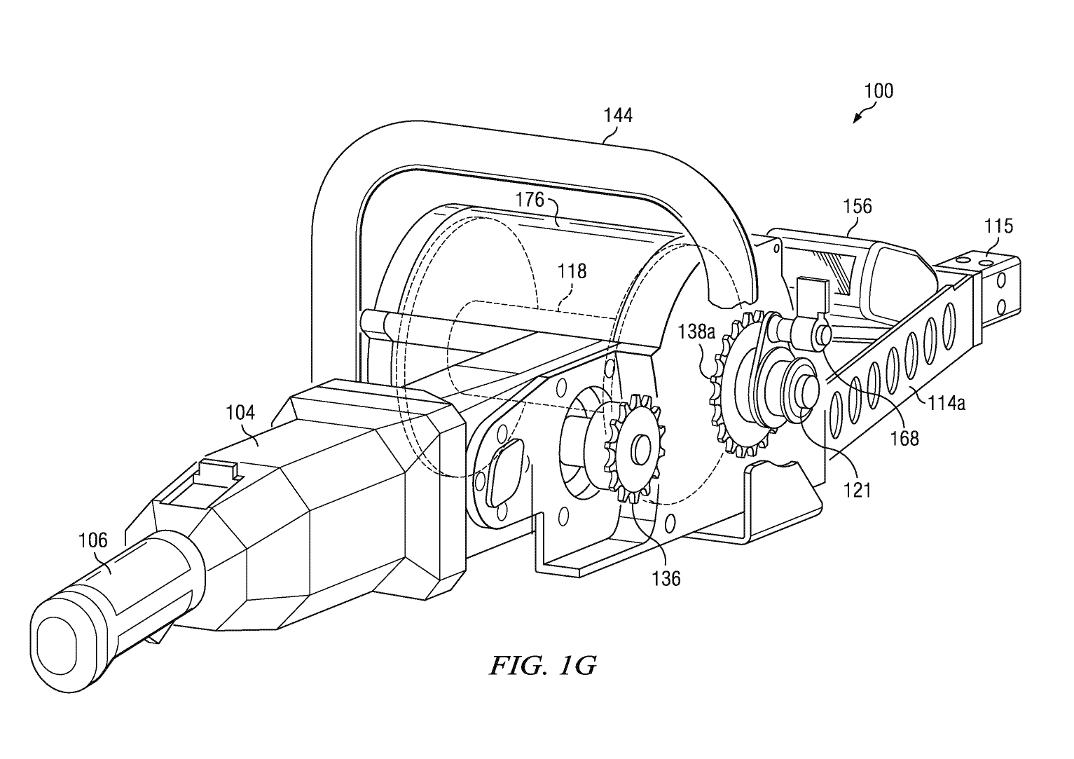

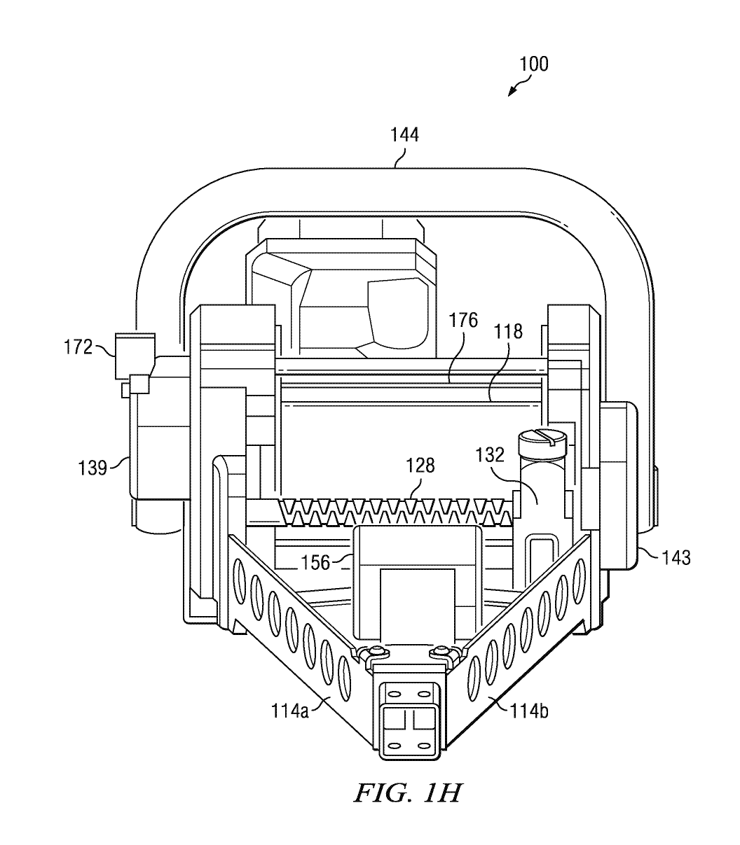

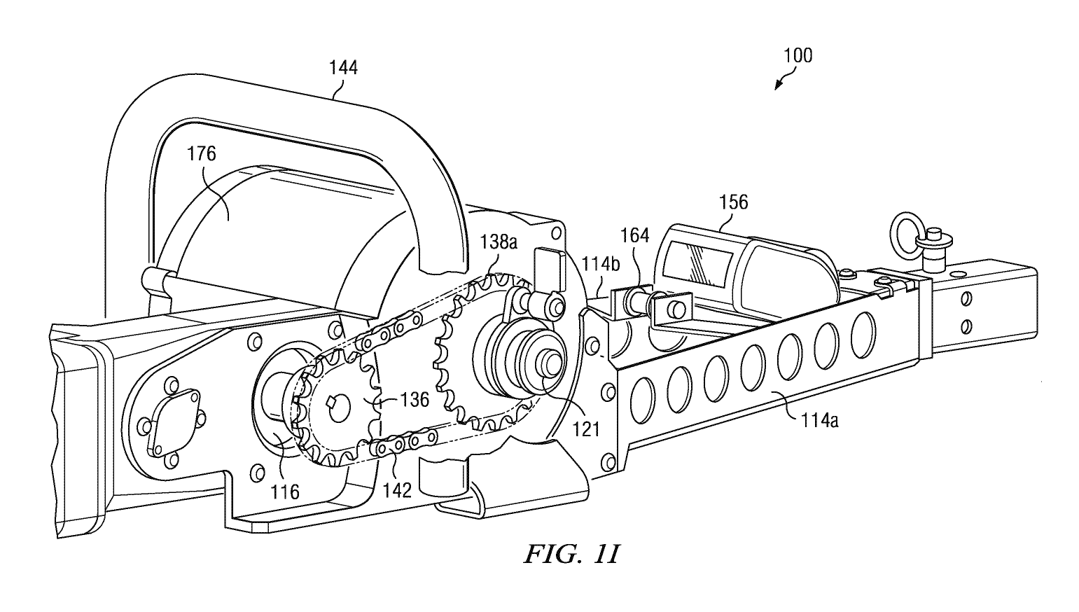

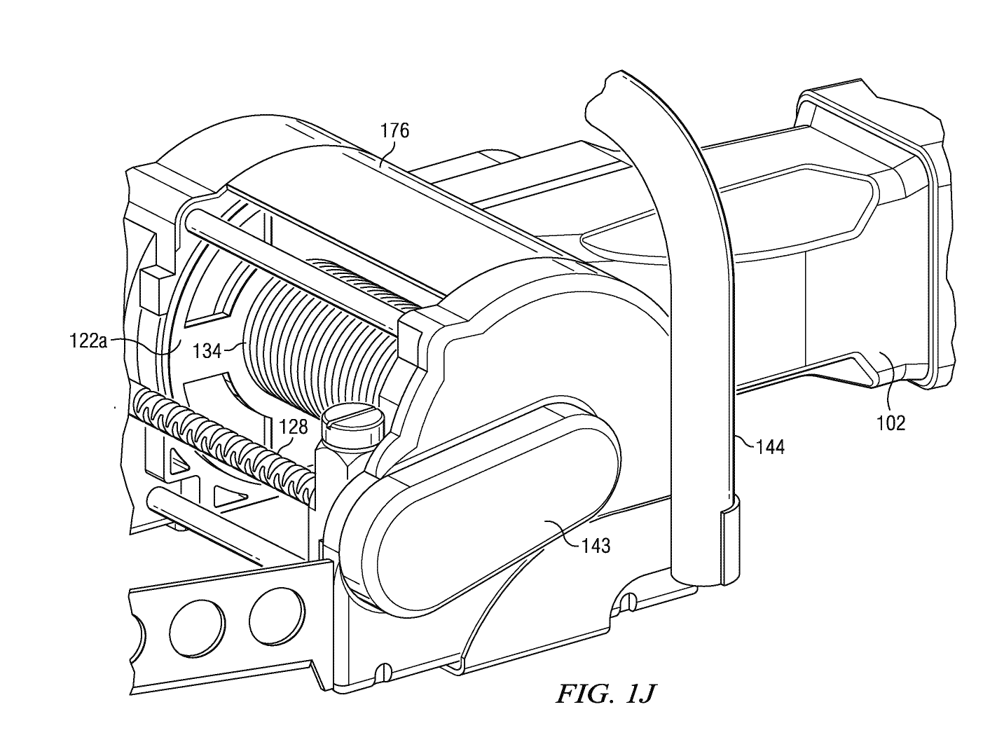

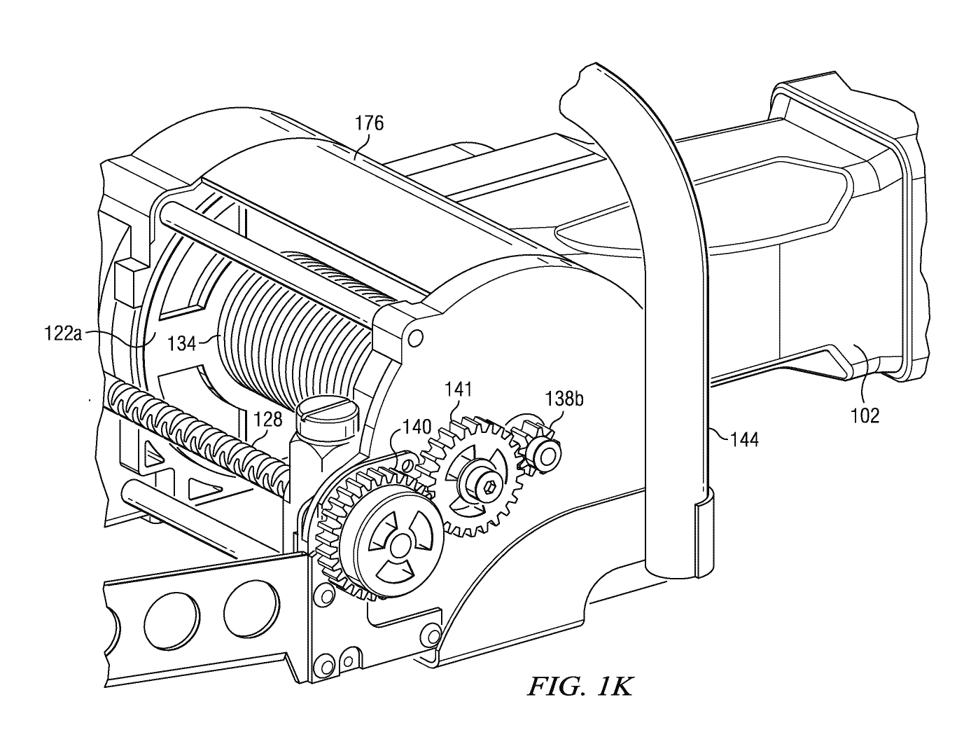

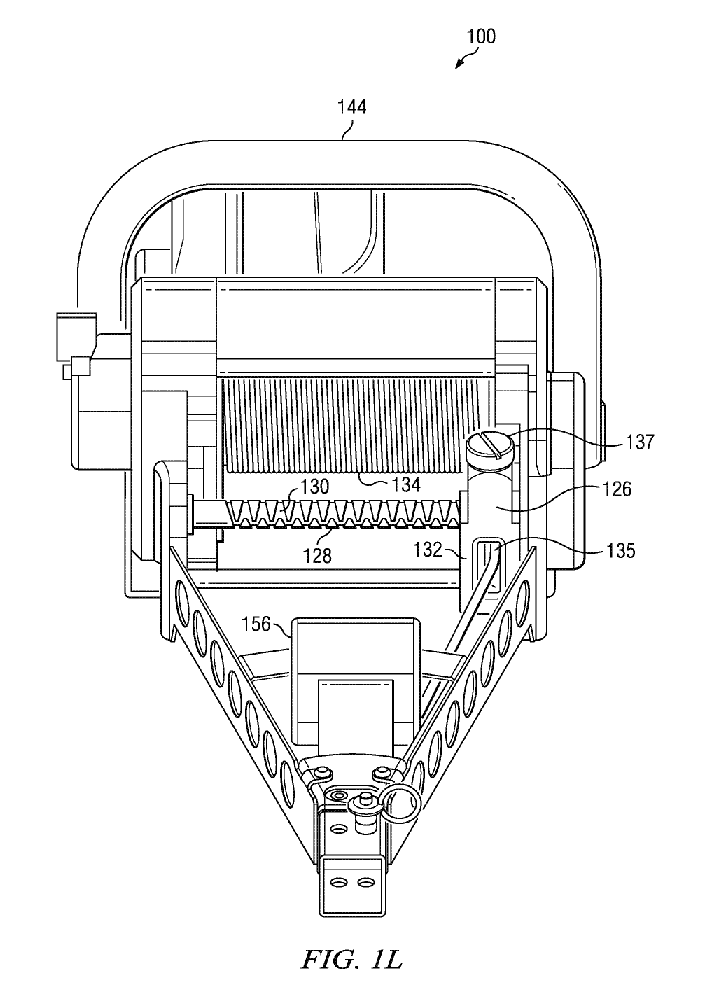

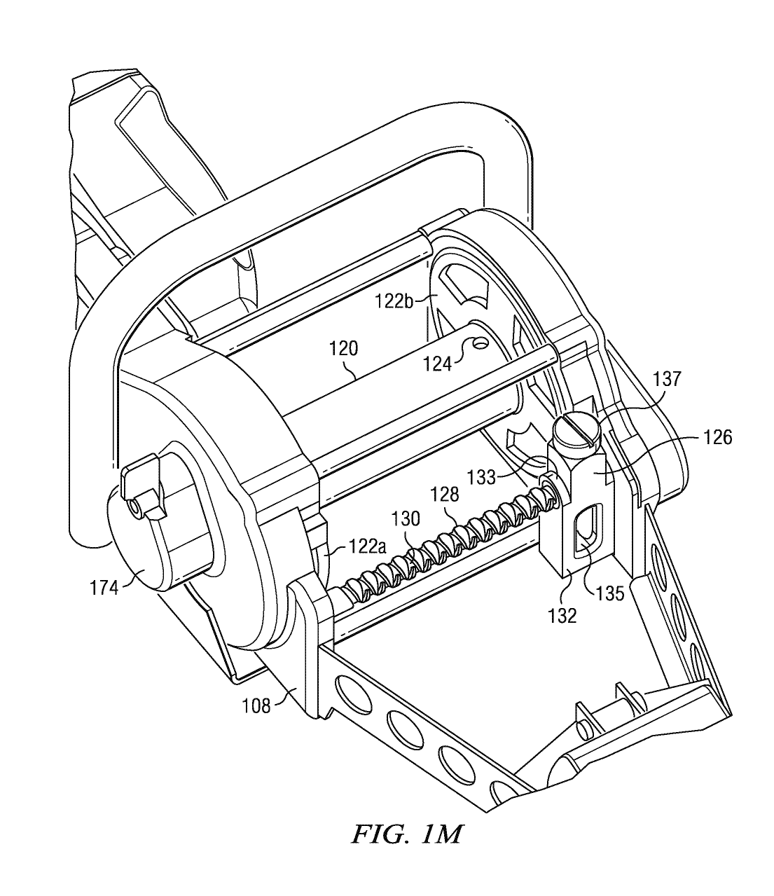

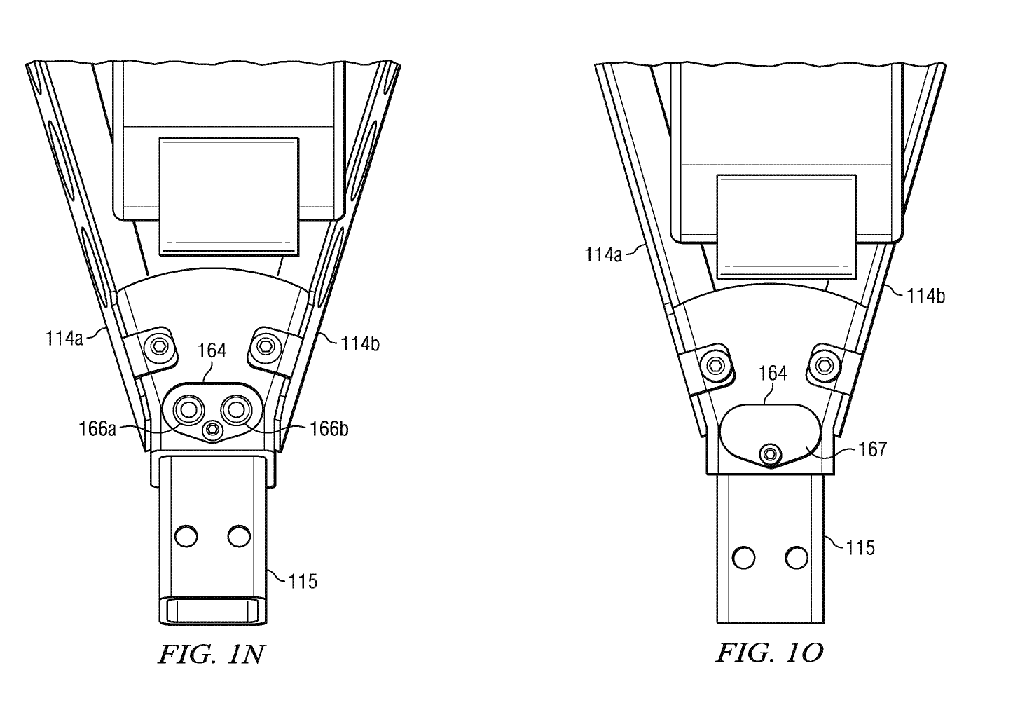

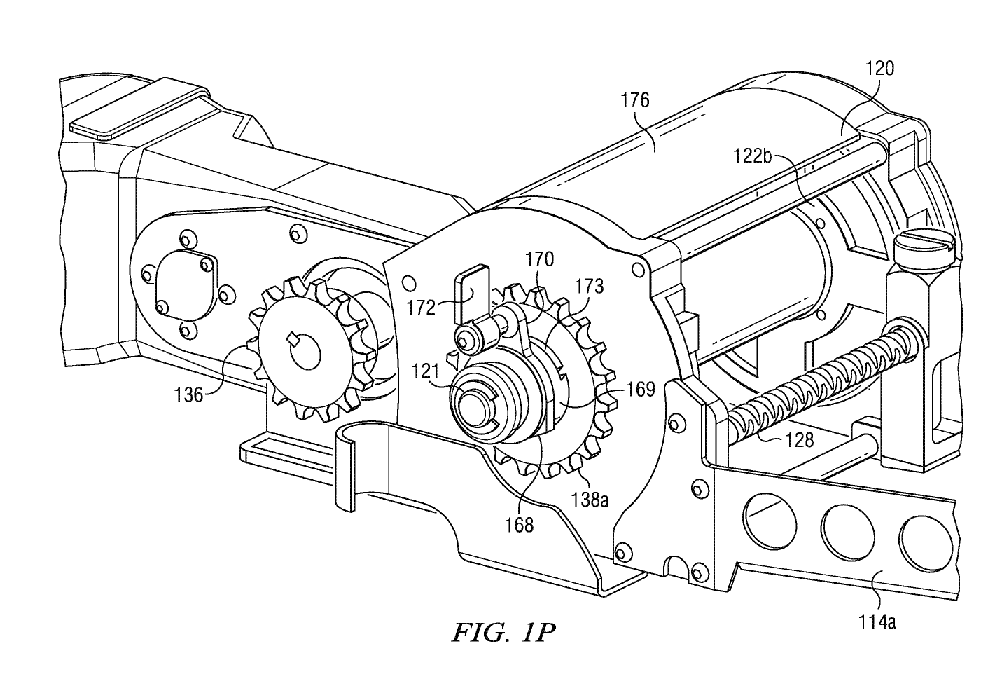

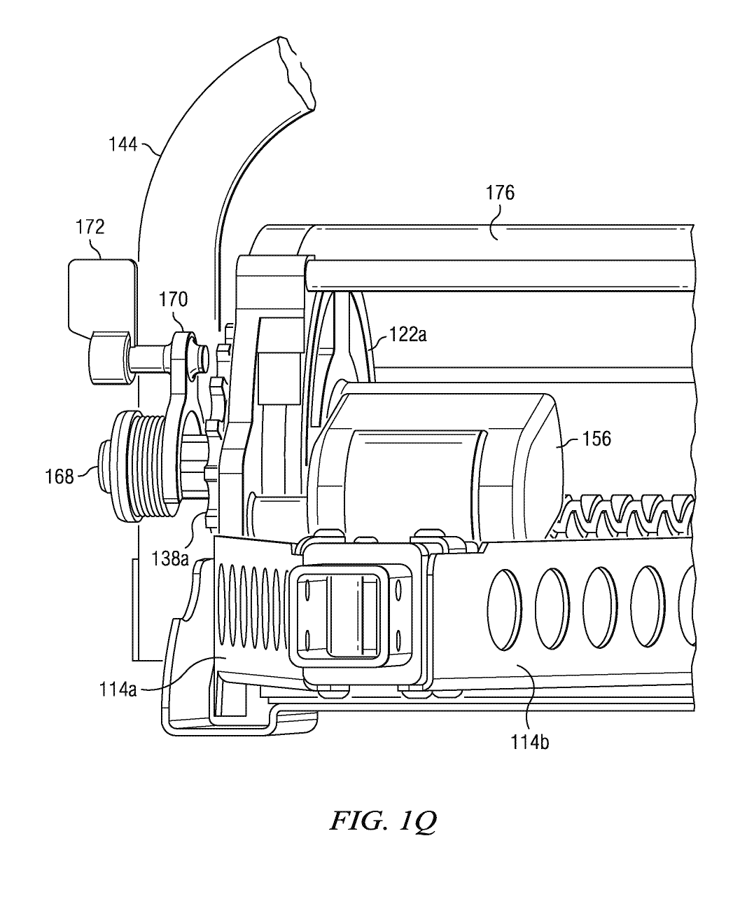

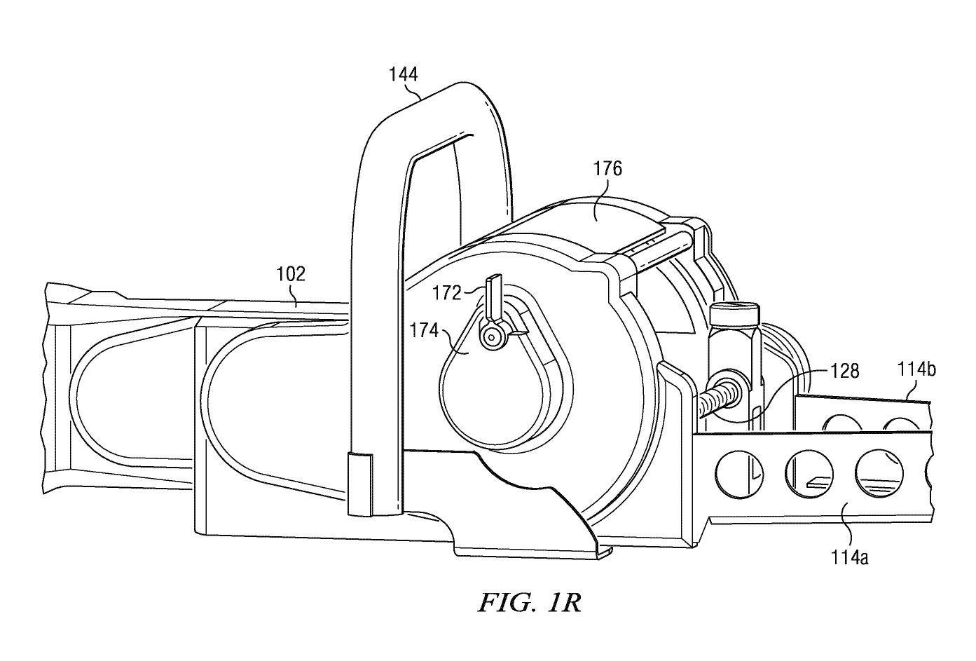

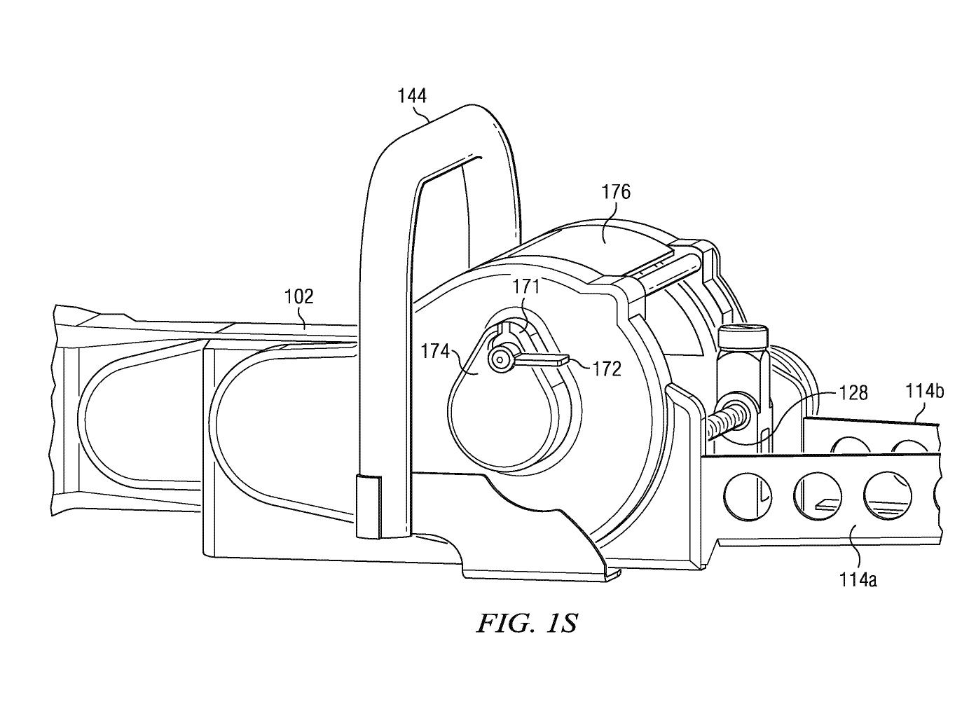

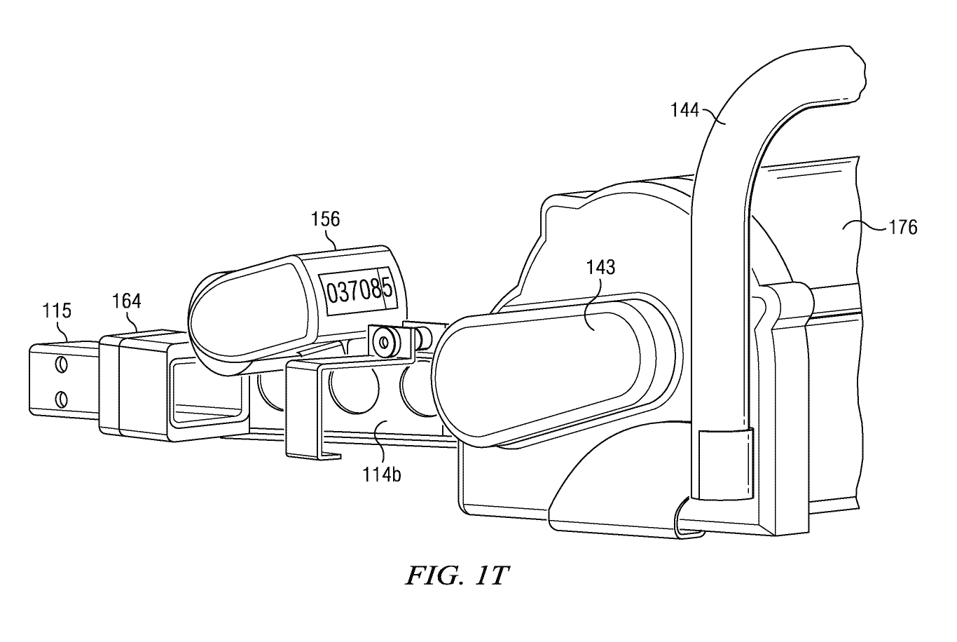

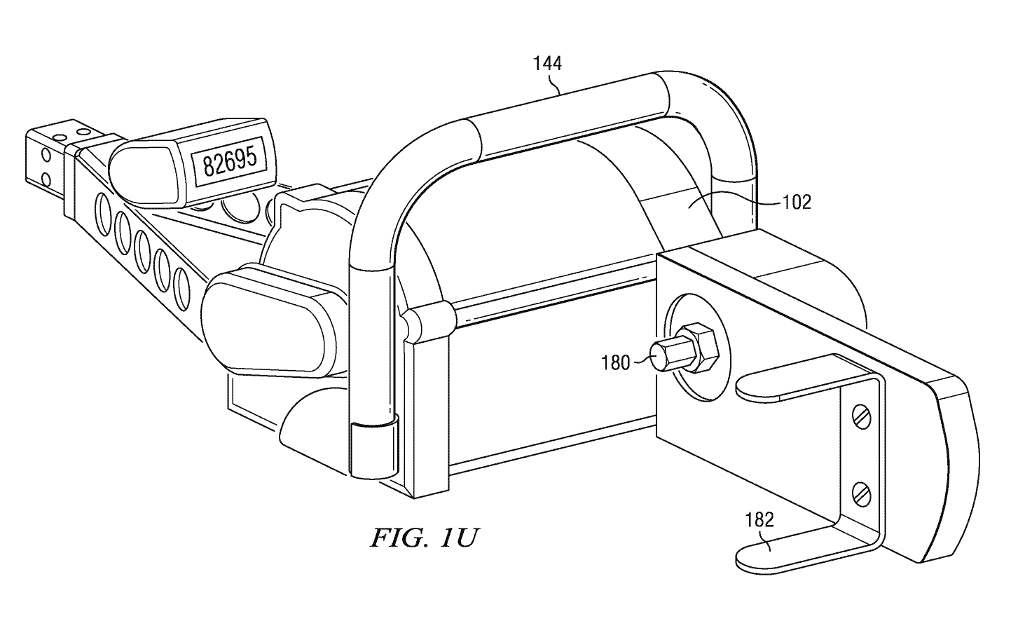

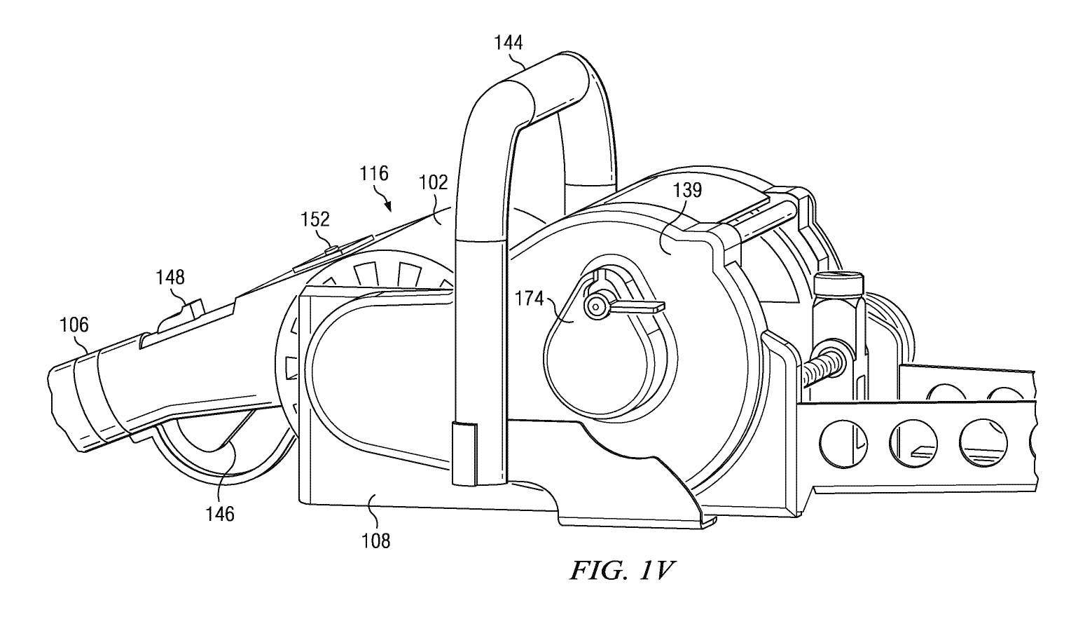

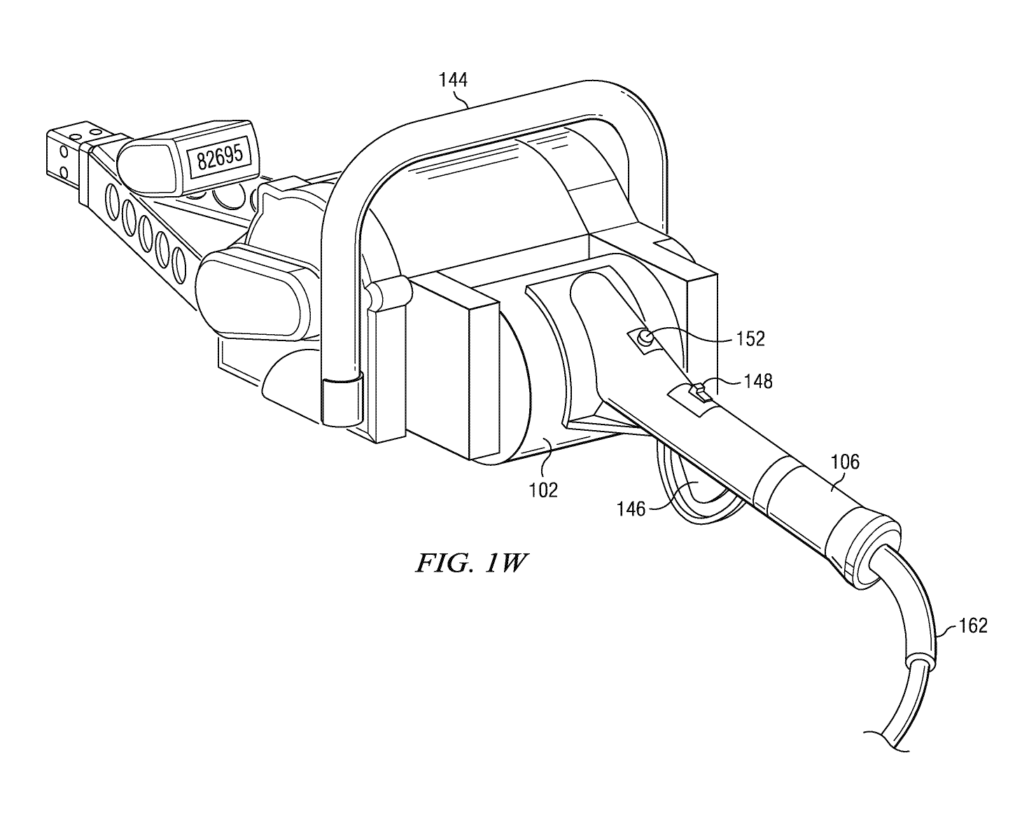

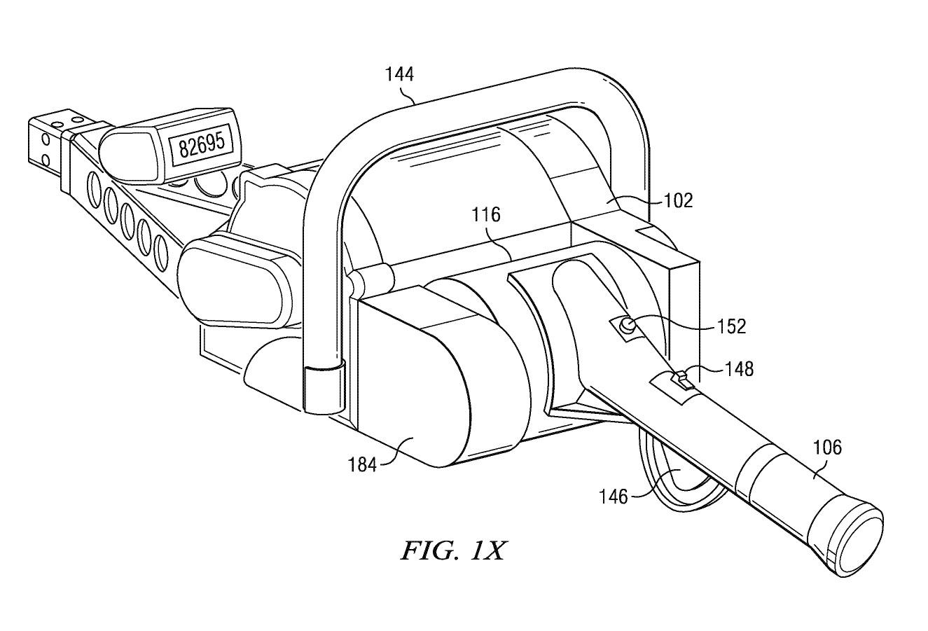

FIGS. 1A-1T illustrate an embodiment of a handheld cable puller 100. As illustrated in FIGS. 1A-1H, the handheld cable puller 100 includes a drum housing 102 coupled to a motor housing 104 having a first handle portion 106. FIG. 1A illustrates a right side view of the handheld cable puller 100. FIG. 1B illustrates a left side view of the handheld cable puller 100. FIG. 1C illustrates a top view of the handheld cable puller 100. FIG. 1D illustrates a bottom view of the handheld cable puller 100. FIG. 1E illustrates a front-right perspective view of the handheld cable puller 100. FIG. 1F illustrates a rear-left perspective view of the handheld cable puller 100. FIG. 1G illustrates a rear-left perspective view of the handheld cable puller 100. FIG. 1H illustrates a front perspective view of the handheld cable puller 100. In various embodiments, the handheld cable puller 100 is portable by a user.

The first handle portion 106 functions as a user interface to allow a user to hold and operate the handheld cable puller 100. The handheld cable puller 100 further includes a frame 108 coupled to the drum housing 102. The frame 108 includes a first frame end 110 and a second frame end 112. In a particular embodiment, the first frame end 110 of the frame 108 is coupled to the drum housing 102. In the particular illustrated embodiment, the frame 108 includes left and right frame portions 109a, 109b, each having a lateral portion with a substantially rectangular form extending from the first frame end 110 to the second frame end 112.

The handheld cable puller 100 further includes a motor 116 disposed within the motor housing 104. The motor 116 has a front portion coupled to the frame 108 proximate to the first frame end 110 and a rear portion proximate to the handle portion 106. In at least one embodiment, the motor 116 may be removably coupled to the frame 108 such that a user may detach the motor housing 104, motor 116, and handle portion 106 from the frame 108. In a particular embodiment, the motor 116 is a right angle drill. In at least one embodiment, the motor 116 is an alternating current (AC) motor. In other embodiments, the motor 116 may be a direct current (DC) motor. A cable drum 118 is rotatably supported on the frame 108 and coupled to the motor 116. Although the current embodiment is illustrated as using a cable drum 118, it should be understood that any other type of cable spool may be used. In various embodiments, the motor 116 is configured to drive rotation of the cable drum 118 at a desired speed and/or direction of rotation in response to control by a user and with a desired torque. Although in the illustrated embodiment the motor 116 is an electric motor, it should be understood that in some embodiments other types of motive devices may be used such as air, hydraulically driven, or hand-cranked motive devices.

Referring now to FIGS. 1L-1M, the cable drum 118 includes a spindle 120, a first drum guide 122a at a first end of the spindle 120, and a second drum guide 122b at a second end of the spindle 120. FIG. 1L illustrates a top perspective view of the cable drum 118. FIG. 1M illustrates a top-right perspective view of the cable drum 118. In at least one embodiment, the spindle 120 includes a spindle hole 124 configured to facilitate attachment of an end of a length of pulling cable 134 to the spindle 120. In a particular embodiment, the spindle 120 is formed of a cylindrical rod rotatably supported on the opposing sides of the frame 108 via a drum shaft 121. In at least one embodiment, the spindle 120 is approximately 2″ in diameter. In the illustrated embodiment, the first and second drum guides 122a, 122b are attached at opposing ends of the spindle 120 and are formed of substantially circular plates, each having a diameter greater than a diameter of the spindle 120. The first and second drum guides 122a, 122b are adapted to retain the pulling cable 134 on the spindle 120 during winding of the pulling cable 134 on the cable drum 118. In at least one embodiment, the pulling cable is a high strength wire cable coated with a material having a low coefficient of friction such as polytetrafluoroethylene (PTFE) or Hexaflon. In a particular embodiment, the low friction material has a coefficient of friction of less than 0.1. In still another embodiment, the low friction material has a coefficient of friction of between 0.04 and 0.1. In a particular embodiment, the pulling cable 134 is 3/32″ diameter braided stainless steel cable. In various embodiments, the relatively small diameter pulling cable 134 allows for a desired length of pulling cable 134 to be wound on the spindle 120 without increasing the weight of the handheld cable puller 100 to an undesired level.

The handheld cable puller 100 further includes a cable winding guide 126 rotatably supported on the frame 108. The cable winding guide 126 includes a cable guide shaft 128 having a plurality of cross-cut channels 130 extending along a portion thereof. The cable winding guide 126 further includes a guide portion 132 having a guide shaft hole 133. The cable guide shaft 128 passes through the guide shaft hole 133 and the guide shaft hole 133 engages the cross-cut channels 130. The guide portion 132 may further include an adjustment screw 137 extending through the guide shaft hole 133 which may be adjusted to be in engagement with the cross-cut channels 130 of the cable guide shaft 128. The pulling cable 134 passes through a cable guide slot 135 of the guide portion 132 of the cable winding guide 126. In a particular embodiment, the cable guide slot 135 is of a substantially rectangular shape.

The handheld cable puller 100 further includes, on a right-hand side of the handheld cable puller 100, a motor gear 136 coupled to a shaft of the motor 116, and a first drum gear 138a coupled to the spindle 120 of the cable drum 118. In a particular embodiment, the first drum gear 138a is disposed on the drum shaft 121. A cable shaft drive gear 140 is coupled to the cable guide shaft 128 of the cable winding guide 126. In the particular illustrated embodiment, a drive chain 142 couples the motor gear 136 to the first drum gear 138a. The handheld cable puller 100 may further include a removable right gear cover 139 which may be attached to the drum housing 102 to cover the motor gear 136, the first drum gear 138a, and the drive chain 142. FIG. 1G illustrates a right-rear perspective view of the handheld cable puller 100 in which the removable right gear cover has been removed. FIG. 1I illustrates a close-up perspective view of the handheld cable puller 100 with the removable right gear cover 139 removed in which the motor gear 136, the first drum gear 138a, and the drive chain 142 can be more clearly seen. In still other embodiments, other methods may be used to couple the motor 116 to the cable drum 118, such as the user of one or more gears or direct drive of the cable drum 118 by the motor 116.

Referring again to FIGS. 1L-1M, the handheld cable puller 100 further includes, on a left-hand side of the handheld cable puller 100, a second drum gear 138b coupled to the spindle 120 of the cable drum 118, and a cable shaft drive gear 140 coupled to the cable guide shaft 128. In a particular embodiment, the second drum gear 138b is disposed on the drum shaft 121. The handheld cable puller 100 further includes a coupling gear 141 mounted to the frame 108 and configured to rotationally couple the second drum gear 138b to the cable shaft drive gear 140. As illustrated in FIG. 1J, the handheld cable puller may further include a removable left gear cover 143 which may be attached to the drum housing 102 to cover the second drum gear 138b, the cable shaft drive gear 140, and the coupling gear 141. FIG. 1K illustrates a close-up perspective view of the handheld cable puller 100 with the removable left gear cover 143 removed in which the second drum gear 138a, the cable shaft drive gear 140, and the coupling gear 141 can be more clearly seen. Although the present embodiment is illustrated as showing a single coupling gear 141, in other embodiments a number of gears may be used in accordance with producing a desired gear ratio between the second drum gear 138b and the cable shaft drive gear 140.

Upon rotation of the motor gear 136 by the motor 116, the cable drum 118 is driven at a predetermined speed of rotation relative to the speed of rotation of the motor 116. In addition, the cable guide shaft 128 is driven at a predetermined speed of rotation relative to the speed of rotation of the cable drum 118. The speed of rotation of each of the cable drum 118 and the cable drive shaft 128 relative to the motor 116 are determined based on the respective gear ratios of the motor gear 136, the first drum gear 138a, the second drum gear 138b, the cable shaft drive gear 140, and the coupling gear 141. It should be understood that the particular scales and gear ratios illustrated are shown for ease of illustration and are not necessarily representative of the particular scales and gear ratios that may be used. It should also be understood that in various embodiments, the sizes and/or gear ratios of the motor gear 136, the first drum gear 138a, the second drum gear 138b, the cable shaft drive gear 140, and the coupling gear 141 may be chosen to achieve a desired speed of rotation of the cable drum 118 and the cable guide shaft 128 relative to the speed of rotation of the motor 116. Although the illustrated embodiments use gears and a drive change 142 to couple the motor 116 to the cable drum 118 and the cable guide shaft 128, it should be understood that in other embodiments other methods for coupling may be used such as belt drives, worm drives, cable drives, etc. Also, the motor 116 utilizes a worm gear configuration (not shown) to convert a rotation about one axis to a rotation perpendicular thereto.

In the illustrated embodiment, the handheld cable puller 100 further includes a second handle portion 144 affixed to the frame 108. The second handle portion 144 allows a user to grasp the second handle portion 144 with a second hand to allow greater control of the movement of the handheld cable puller 100. In the illustrated embodiment, the second handle portion 144 is a substantially u-shaped grip having a substantially cylindrical cross-section affixed to the left and right sides of the frame 108. In still other embodiments, the second handle portion 144 may be of any form suitable for grasping by a hand of a user. In still other embodiments, the second handle portion 144 may be omitted.

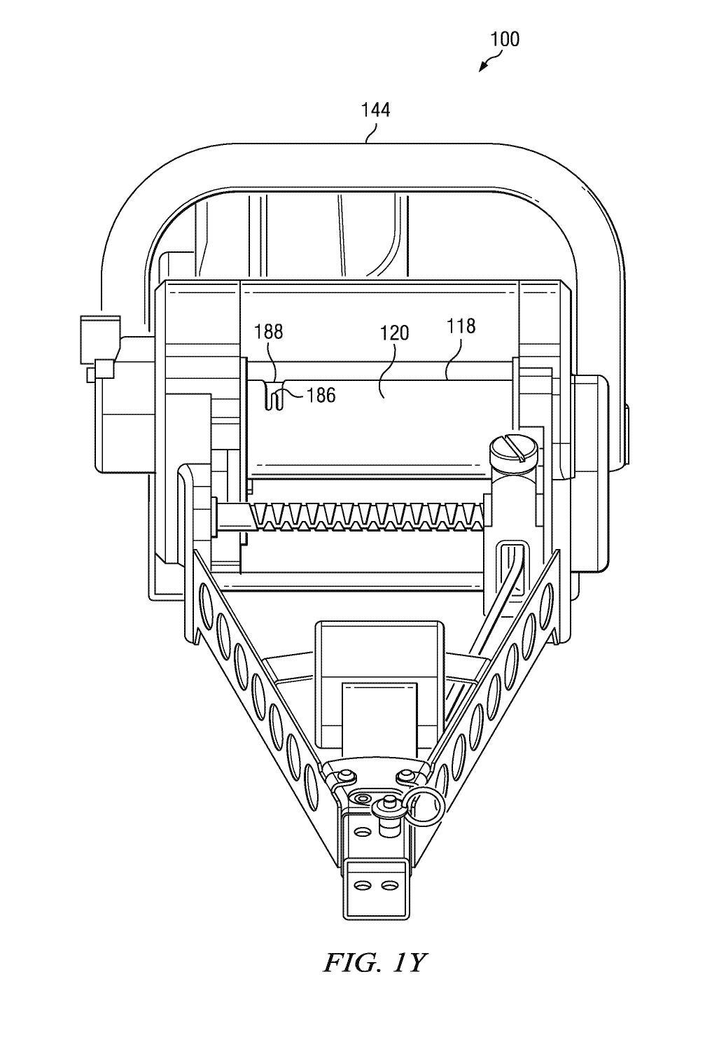

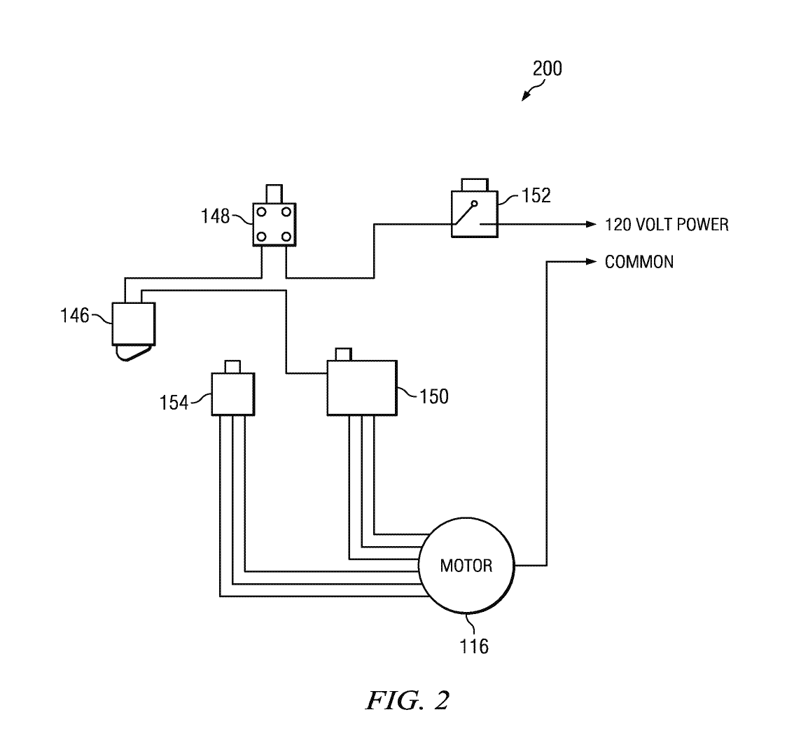

In at least one embodiment, the handle-held cable puller 100 includes one or more user controls including a finger control switch 146 on a bottom portion of a first handle portion 106, and a forward/reverse switch 154 on a top portion of the first handle portion 106. As illustrated in FIG. 2, the handheld cable puller 100 may further include in other embodiments a thumb safety switch 148, a speed control switch 150, and a thermal overload switch 152. Operation of the finger control switch 146, thumb safety switch 148, speed control switch 150, thermal overload switch 152 and the forward/reverse switch 154 are described further with respect to FIG. 2.

The handheld cable puller 100 further includes attachment arms 114a, 114b coupled to the second frame end 112. In at least one embodiment, a first end of attachment arm 114a is coupled to a right side of the second frame end 112, a second end of attachment arm 114b is coupled to a left side of the second frame end 112, and a second end of the attachment arm 114a and a second end of the attachment arm 114b are coupled proximate to one another to form a substantially v-shape. A pulling arm 158 having a first pulling arm end is configured to be coupled to an attachment end 115 of the attachment arms 114a, 114b. In a particular embodiment, the pulling arm 158 is coupled to the attachment arm 114 via a snap-lock mechanism at the attachment end 115. In at least one embodiment, the pulling arm 158 may be secured in its attachment to the attachment end 115 via an attachment pin 117 that may be placed through holes in the attachment end 115 and the pulling arm 158. In still other embodiments, the pulling arm 158 and the attachment arm 114 may be formed as an integrated unit permanently affixed to the second frame end 112 of the frame 108.

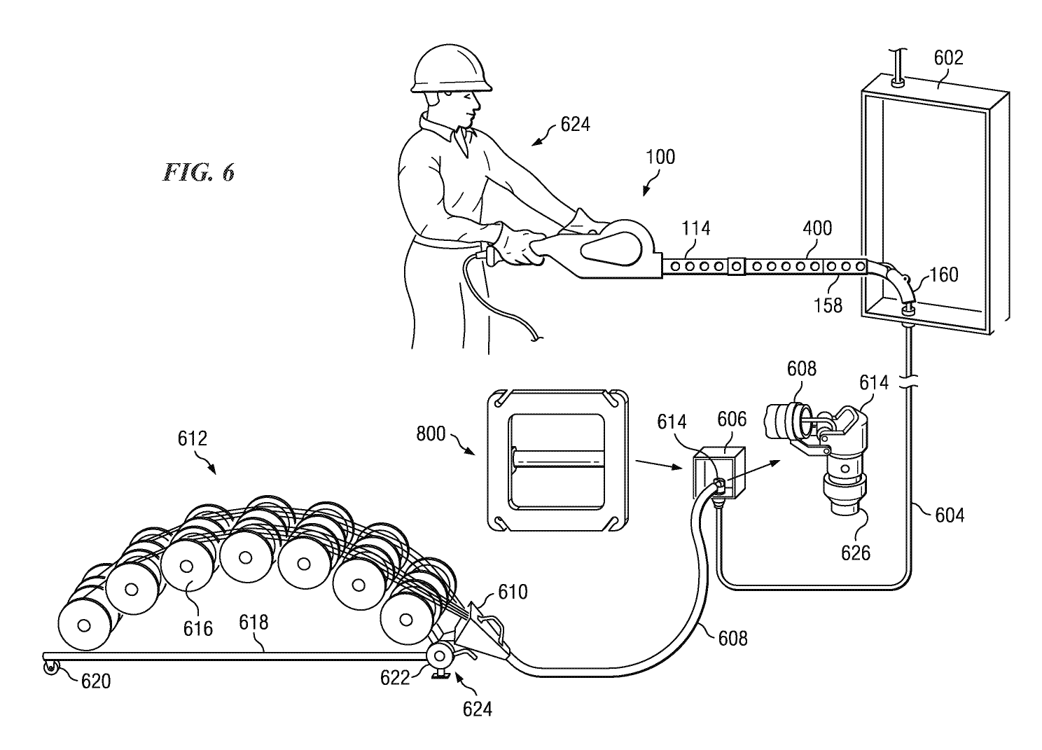

A second pulling arm end of the pulling arm 158 is coupled to a pulling head 160. The pulling cable 134 runs through the pulling arm 158 and the pulling head 160. In at least one embodiment, one or more of the pulling arm 158 and the pulling head 160 may be provided with one or more rollers to facilitate movement of the pulling cable 134 along the pulling arm 158 and the pulling head 160. In at least one embodiment, the pulling head 160 is configured to be placed against an open end of a conduit during a pulling operation during which the pulling cable 134 pulls one or more cables or wires through a length of the conduit as the pulling cable 134 is wound upon the cable drum.118. The pulling arm 158 functions as an interface for abutting proximate to an end of a conduit or other raceway to substantially absorb resistive forces from the pulling cable 134 during rewinding. An example operation of the handheld cable puller 100 will be further described with respect to FIG. 6. In at least one embodiment, the handheld cable puller 100 further includes a power cord 162 adapted for coupling the handheld cable puller 100 to a power source. In a particular embodiment, the power cord is adapted for coupling the handheld cable puller 100 to an alternating current (AC) power source. In other embodiments, the handheld cable puller 100 may include a power source such as a battery coupled thereto for powering the motor 116 (where the motor 116 comprises a DC motor). In still other embodiments, the handheld cable puller 100 may be provided with an air or hydraulic connection for some embodiments in which the handheld cable puller 100 may be powered by an air or hydraulic motor.

The handheld cable puller 100 further includes a line length meter 156 disposed on the attachment arms 114. The line length meter 156 is configured to measure the length of the pulling cable 134 unwound or released from the cable drum 118. In other embodiments, the line length meter 156 may also measure the line length of the pulling cable 134 re-wound on the cable drum 118 during a winding operation. FIG. 1I illustrates a close-up right-side perspective view of the line length meter 156. FIG. 1T illustrates a close-up left-side perspective view of the line length meter 156.

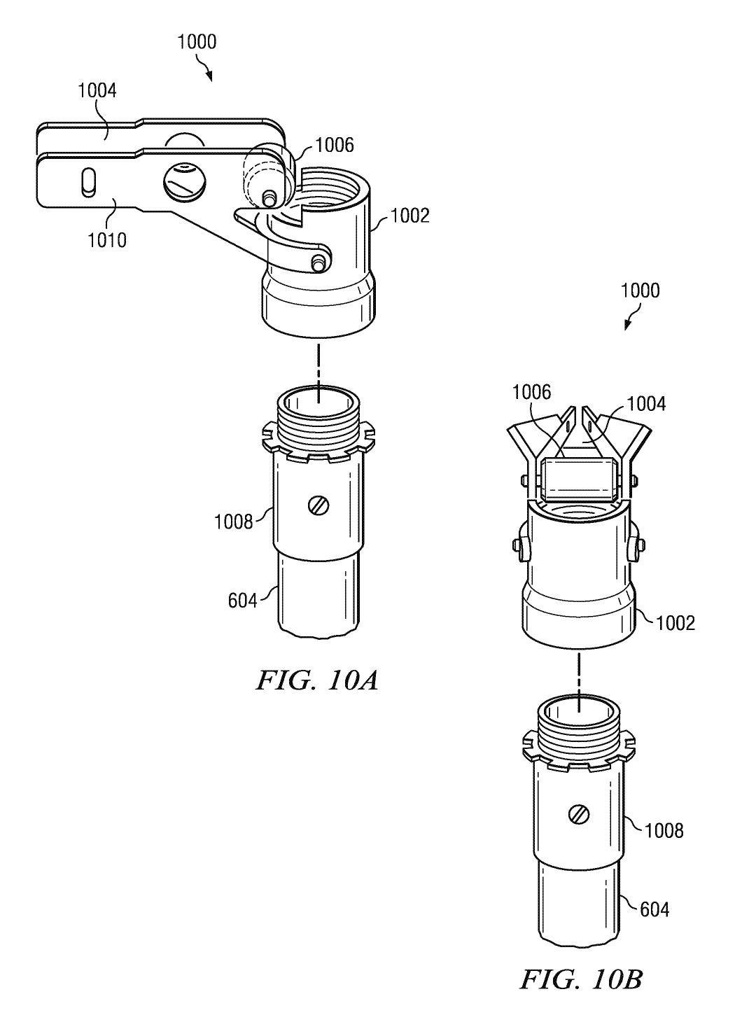

Referring to FIGS. 1N-10, the handheld cable puller 100 further includes a fixed cable guide 164 disposed on the end of the attachment arms 114a, 114b forward of the line length meter 156. FIG. 1N illustrates a top perspective view of the fixed cable guide 164. The fixed cable guide 164 further facilitates guiding of the pulling cable 134 as it is wound or unwound from the cable drum 118. In a particular embodiment, the fixed cable guide 164 includes one or more cable guide rollers 166a, 166b to facilitate guiding of the pulling cable 134. FIG. 10 illustrates a top view of the cable guide 164 that includes a roller cover 167 which may be attached to the fixed cable guide 164 to cover the cable guide rollers 166a, 166b. In at least one embodiment, the one or more cable guide rollers 166a, 166b may be replaced when desired, such as when they show signs of excessive wear, by removal of the roller cover 167, removal and replacement of the one or more cable guide rollers 166a, 166b, and replacement of the roller cover 167.

Referring now to FIGS. 1P-1Q, the handheld cable puller 100 may further include a disengagement mechanism 168 disposed on the drum shaft 121 proximate to the first drum gear 138a. FIG. 1P illustrates a close-up right perspective view of the disengagement mechanism 168. FIG. 1Q illustrates a front-right perspective view of the disengagement mechanism 168. In a particular embodiment, the disengagement mechanism 168 includes a yoke 170 coupled to the drum shaft 121. In a particular embodiment, the yoke 170 is substantially fork-shaped. The disengagement mechanism 168 further includes a disengagement handle 172 attached to the yoke 170. Upon placing of the disengagement mechanism 168 into an engaged position by a user, the disengagement mechanism 168 moves the first drum gear 138a into engagement with the drum shaft 121. In the engaged position, rotation of the first drum gear 138a by the motor gear 136 results in rotation of the cable drum 118. FIG. 1R illustrates a close-up view of the disengagement mechanism 168 in the engaged position in which a disengagement mechanism cover 174 covers the disengagement mechanism 168 with the exception of the disengagement handle 172. Upon placing of the disengagement mechanism 168 is a disengaged position by the user, the disengagement mechanism 168 moves the first drum gear 138a out of engagement with the drum shaft 121. In the disengaged position, the pulling cable 134 may be played out or unwound from the spool by a user. FIG. 1S illustrates a close-up view of the disengagement mechanism 168 in which the disengagement mechanism cover 174 covers the disengagement mechanism 168 with the exception of the disengagement handle 172. When disengagement handle 172 is rotated clockwise, it cooperates with a beveled surface 171 on disengagement mechanism cover 174 to cause yoke 170 to cant, thus pulling engagement teeth 169 out of engagement with teeth 173 on gear 138a.

In some embodiments, the handheld cable puller 100 may include a shield 176 affixed to the housing above the cable drum 118 to protect a user from the cable drum 118. In a particular embodiment, the shield 176 is of a substantially arcuate shape. In at least one embodiment, the shield 176 may be constructed of a transparent or translucent material to allow viewing of the operation of the cable drum 118 by a user during use.

FIG. 1U illustrates a left-rear perspective view of the handheld cable puller 100 in which the motor 116 has been removed from the handheld cable puller 100. As illustrated in FIG. 1U, the handheld cable puller 100 includes an adaptor 180 configured to couple the shaft of the motor 116 to the motor gear 136. In a particular embodiment, the adaptor 180 is an ½″ octagonally-shaped threaded adaptor that is configured to reverse thread onto the shaft of the motor 116. In at least one embodiment, the adaptor 180 may be configured to shear when the applied torque is greater than a predetermined value in order to prevent damage to the handheld cable puller 100. The handheld cable puller 100 may further include a u-shaped support bracket 182 configured to bind the motor 116 in a fixed position when used to drive the handheld cable puller 100.

FIG. 1V-1W illustrates another embodiment of the handheld cable puller 100. FIG. 1V illustrates a right perspective view of the handheld cable puller 100. FIG, 1W illustrates a left-rear perspective view of the handheld cable puller 100. In the embodiment illustrated in FIG. 1U, the motor 116 is integrated with the handheld cable puller 100 and disposed within a housing 102. In the particularly illustrated embodiment, the housing includes vent holes to allow venting of the motor 116. The first handle portion 106 includes a finger control switch 146, a thumb safety switch 148, and a thermal overload switch 152. The handheld cable puller 100 may include a power cord 162 adapted for coupling the handheld cable puller 100 to a power source.

FIG. 1X illustrates a right-rear perspective view of still another embodiment of the handheld cable puller 100. In the embodiment illustrated in FIG. 1X, the handheld cable puller 100 may include a power source 184 removably coupled to the housing 102 for powering the motor 116. In a particular embodiment, the power source 184 is a cordless battery.

FIG. 1Y illustrates another embodiment of the cable drum 118. In the embodiment of FIG. 1Y, the surface of the spindle 120 of the cable drum 118 includes a hook 186 and a depressed area 188. Instead of a pulling cable 134 being wound on the spindle 120, an end of a jetline, or other type of pulling cable or line, that has been previously run through a conduit may be attached to the hook 186. One or more pulled cables may then be attached to an opposite end of the jetline, and the handheld cable puller 100 may be operated to wind the jetline around the spindle 120 thereby pulling the pulled cables through the conduit. Thus, there are two uses contemplated by the tool. The first is to unwind cable from the spool utilizing the jetline, attaching a wire or wires thereto, and rewinding the cable. The second is to attach the jetline to the spool and rewind the jetline on the spool to pull the wire.

Further referring to FIG. 1Y, an alternate embodiment has been described that allows the cable to be removed and the jetline to be utilized for the pulling operation. In this operation, the jetline is blown through the conduit such that it extends out at the end at which the tool operator resides. The other end is attached to wire at the feeder end. The jetline will be run through the extension and attached to the tab 188. As such, the rewind operation with the clutch engaged will result in the jetline being wound onto the spool and pulling the wire through. This is useful for phone wire and CATS wire for computer and phone installations. These are fairly light wires to pull through conduit and can be facilitated with the strength of the jetline. The jetline is fully wound onto the spool and then another conduit operated on. This will allow the second conduit to have the jetline tied to the first jetline that is already on the spool and then the wire associated with that conduit pulled through the conduit from the feeder end to the tool operator end and more jetline wound onto the spool in the rewind mode of operation. This can be continued until the spool is full. At this time, multiple conduits have had wire pulled therethrough and the jetline can be unwound from the spool or, alternatively, the spool could be removed and a new spool placed thereon. Further, the spool could be such that it was a two piece spool that could come apart in the middle such that the spool on jetline could be easily removed.

FIG. 2 illustrates an embodiment of a wiring diagram 200 of the handheld cable puller 100. The thermal overload switch 152 has a first terminal connected to a 120 volt power source. The thermal overload switch 152 is configured to remain closed until a current draw of the motor 116 exceeds a predetermined value at which time the switch opens to remove power from the motor 116. A second terminal of the thermal overload switch 152 is connected to a first terminal of the thumb safety switch 148. The thumb safety switch 148 is configured in at least one embodiment to be normally open until depressed by a user, such as by a thumb, during operation of the handheld cable puller 100. Accordingly, in the illustrated embodiment power is not supplied to the motor 116 unless the thumb safety switch 148 is depressed. In a particular embodiment, the thumb safety switch 148 is spring loaded to remain in an open position when a user is not depressing the thumb safety switch 148. A second terminal of the thumb safety switch 148 is connected to a first terminal of the finger control switch 146. The finger control switch 146 is configured to activate the motor 116 upon depression of the switch by a user. In at least one embodiment, the finger control switch 146 is a variable speed switch in which the rotational speed of the motor 116 may be controlled by the extent of the squeezing of the finger control switch 146. A second terminal of the finger control switch 146 is connected to the speed control switch 150. The speed control switch 150 is configured to control the speed of rotation of the motor 116. In a particular embodiment, the speed control switch 150 may be set at a low, a medium, or a high speed by the user. A second terminal of the speed control switch 150 is coupled to the motor 116. The forward/reverse switch 154 is further coupled to the motor 116. The forward/reverse switch 154 is configured to allow the user to alternate the direction of rotation of the motor 116 to either wind or unwind the pulling cable 134 from the cable drum 118. For example, in a forward position of the forward/reverse switch 154, the motor 116 is driven to unwind the pulling cable 134 from the cable drum 118. In a reverse position of the forward/reverse switch 154, the motor 116 is driven to wind the pulling cable 134 on the cable drum 118. The motor 116 is further connected to a common terminal of the 120 volt power supply. Although the illustrated embodiment uses an AC motor 116, it should be understood that, in other embodiments, a DC motor may be used. In addition, although the illustrated embodiment includes a number of user controls, it should be understood that in other embodiments, one or more of the user controls may be omitted.

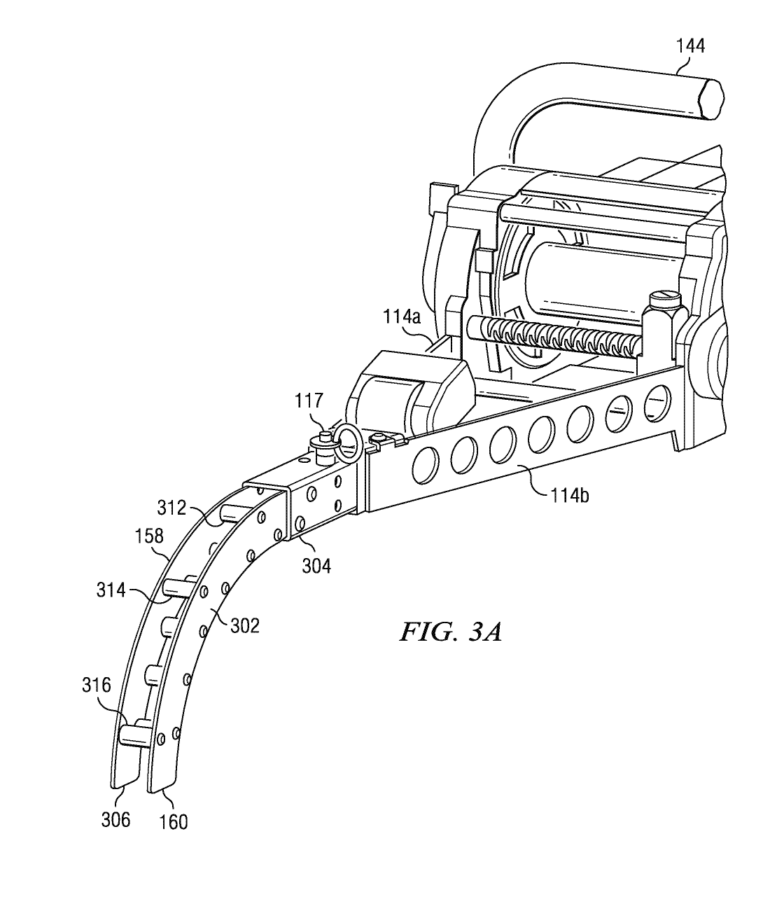

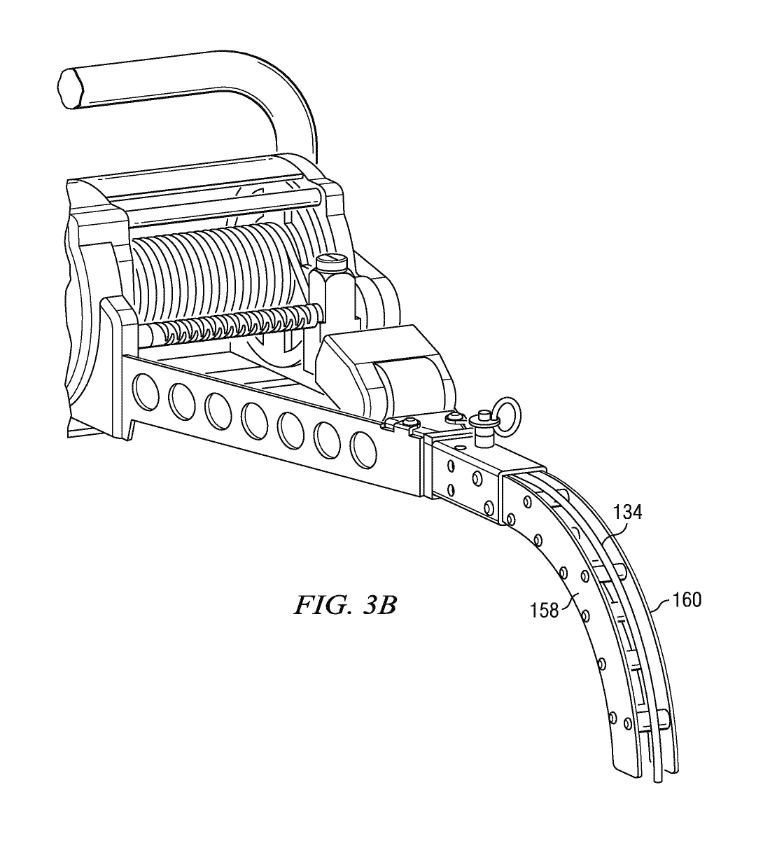

FIGS. 3A-3B illustrate an embodiment of the pulling arm 158 and pulling head 160 of the handheld cable puller 100 of FIG. 1A-1T. FIG. 3A illustrates a left-front perspective view of the pulling arm 158 with pulling head 160. FIG. 3B illustrates a right-front perspective view of the pulling arm 158 with pulling head 160. In the embodiment illustrated in FIGS. 3A-3B, the pulling arm 158 is coupled to the attachment arms 114a, 114b of the handheld cable puller 100 and secured by the attachment pin 117. The pulling arm 158 includes a pulling arm frame 302 having a male attachment end 304 and a pulling head end 306. In the embodiment illustrated in FIGS. 3A-3B, the angle between the male attachment end 304 and the pulling head end 306 is substantially 90 degrees. In still another embodiment, the angle between the male attachment end 304 and the pulling head end 306 is greater than zero degrees. In still another embodiment, the angle between the male attachment end 304 and the pulling head end 306 is variable. The male attachment end 304 is adapted to couple the pulling arm 158 to the attachment arms 114a, 114b of the handheld cable puller 100. Additionally, the male attachment end 304 can be coupled at different angles to rotate the end of the attachment such that the pulling head 160 is directed downwards, left, right, or upwards.

The pulling arm 160 includes a first roller 312, a second roller 314 and a third roller 316. The first roller 312 is rotatably supported at a first end of the pulling arm frame 302 proximate to the male attachment end 304, the second roller 314 is rotatably supported proximate to a middle portion of the pulling arm frame 302, and the third roller 316 is rotatably supported at a second end of the pulling arm frame 402 proximate to the pulling head 160. The first roller 312, the second roller 314 and the third roller 316 are adapted to allow the pulling cable 134 to pass over the upper surfaces thereof. In a particular embodiment, the first roller 312, the second roller 314 and the third roller 316 include sealed, stainless, low-heat bearing assemblies to reduce friction between the pulling cable 134 and the pulling head 160. In a particular embodiment, the pulling arm frame 302 and the pulling head frame 310 may be formed of aluminum or any other suitable material and many include one or more holes to allow for viewing of the pulling cable 134 and/or weight reduction. In various embodiments, the pulling arm 158 may be constructed in various desired lengths.

In the embodiment illustrated in FIGS. 3A-3B, the pulling arm 158 and pulling head 160 are integrated. In an alternative embodiment, the pulling arm 158 and the pulling head 160 may be separate units with the pulling arm 158 coupled to the pulling head 160 via a pulling head hinge. The pulling head hinge is adapted to allow the pulling head 160 to articulate in relation to the pulling arm 158. In a particular embodiment, the pulling head hinge is configured to allow a user to lock the pulling head 160 in a desired position.

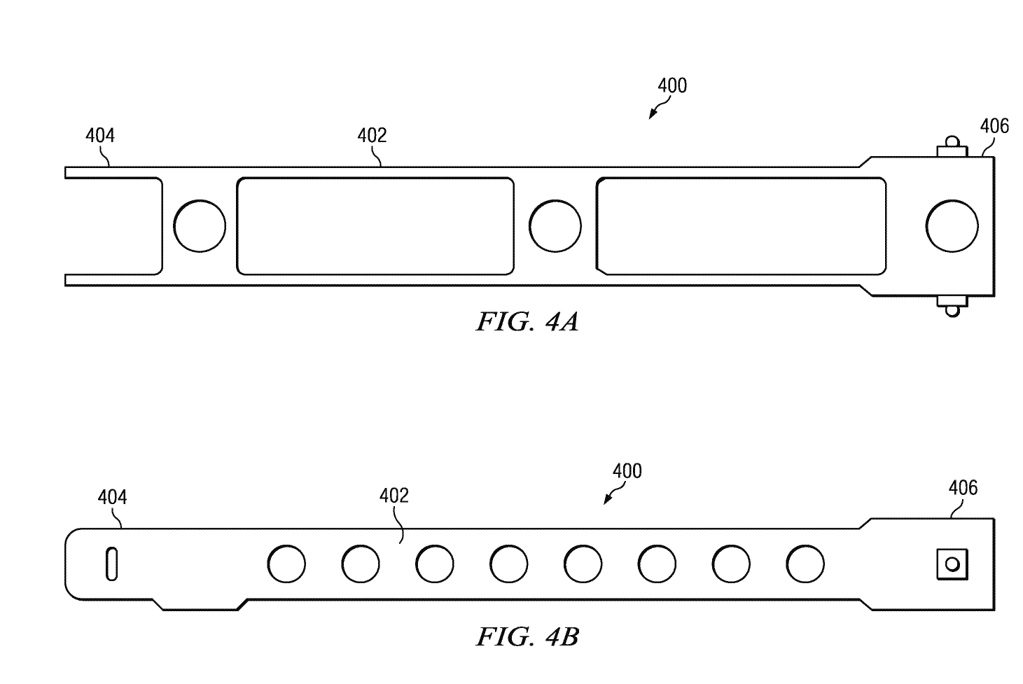

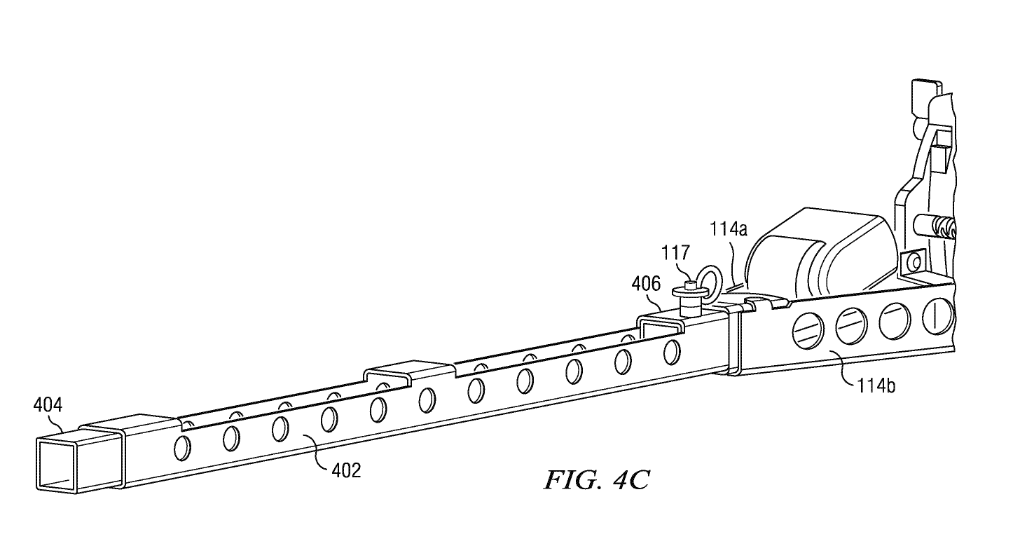

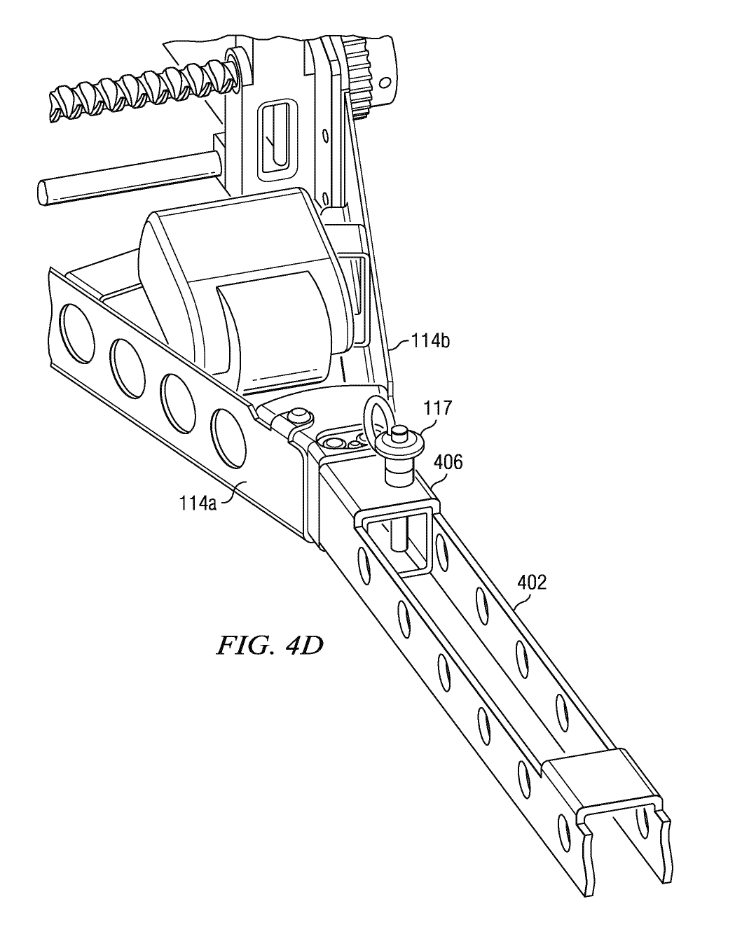

FIGS. 4A-4B illustrate an embodiment of an extension bar 400. The extension bar 400 includes an extension bar frame 402 having a male end 404 and a female end 406. In at least one embodiment, the extension bar 400 is of a predetermined length to provide for a predetermined makeup of the pulled cable upon completion of the pulling operation. The extension bar 400 is configured to extend the length of the pulling bar 158 by coupling the male end 404 to the attachment arms 114a, 114b of the handheld cable puller 100, and coupling the female end 406 of the extension bar 400 to the male attachment end 304 of the pulling arm 158. The extension bar 400 may be provided in any number of desired lengths such as 24 inches in order to leave a desired length of cable, or makeup, exposed after a pulling operation when the cable is fully retracted.

FIGS. 4C-4D illustrate another embodiment of the extension bar 400. FIG. 4B illustrates a left perspective view of the extension bar 400 coupled to the handheld cable puller 100. FIG. 4C illustrates a right perspective view of the extension bar 400 coupled to the handheld cable puller 100. In the embodiment illustrated in FIG. 4B, the female end 406 of the extension bar 400 is coupled to the attachment arms 114a, 114b of the handheld cable puller 100 and secured by the attachment pin 117.

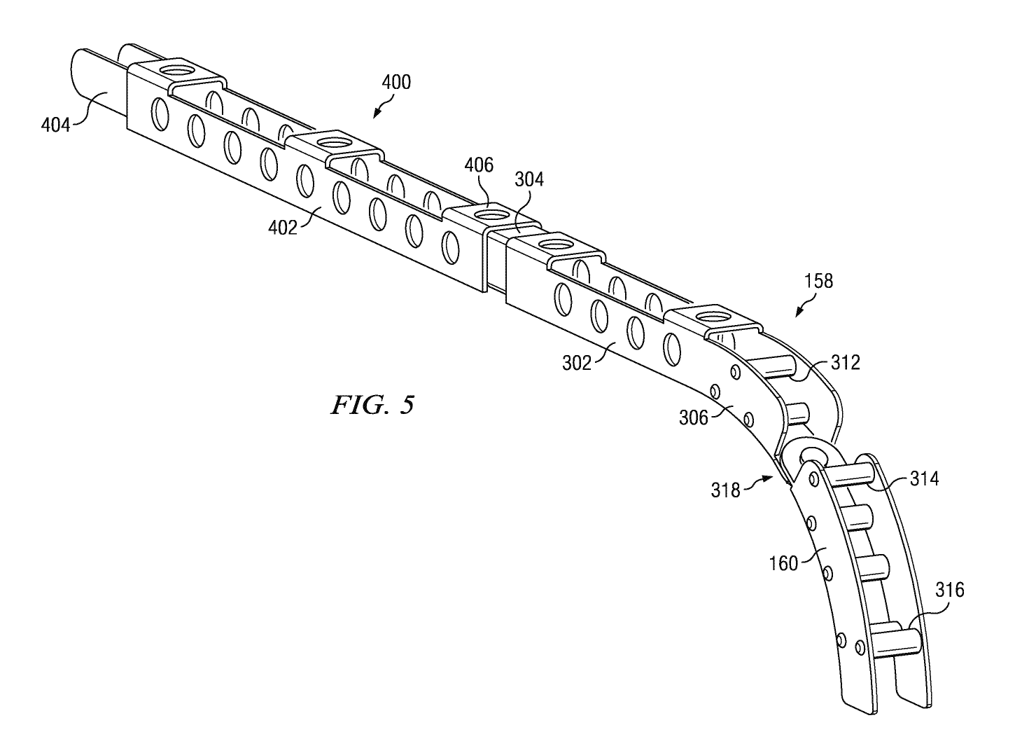

FIG. 5 illustrates a perspective view of an embodiment of the pulling arm 158 and extension bar 400. In the embodiment illustrated in FIGS. 3A-3B, the pulling arm 158 and pulling head 160 are integrated. In the alternative embodiment illustrated in FIG. 5, the pulling arm 158 and the pulling head 160 may be separate units with the pulling arm 158 coupled to the pulling head 160 via a pulling head hinge 318. The pulling head hinge 318 is adapted to allow the pulling head 160 to articulate in relation to the pulling arm 158. In a particular embodiment, the pulling head hinge 318 is configured to allow a user to lock the pulling head 160 in a desired position. In a particular embodiment, the pulling arm 158 and the extension bar 400 may be constructed of 3/16^{th} inch aluminum having a width of 1½inches. As illustrated in FIG. 5, the pulling arm 158 and extension bar 400 may be provided with a number of holes therein to allow for viewing of the pulling cable 134 as well as reduce the weight of the pulling arm 158 and the extension bar 400. In a particular embodiment, the male attachment end 304 of the pulling arm 158 and the female end 406 of the extension bar 400 may be provided with a spring assembly to allow quick attachment and removal of the extension bar 400 from the pulling arm 158. It should be understood that in various embodiments additional extension bars 400 may be added in series in order to extend the pulling arm 158 to a desired length.

FIG. 6 illustrates an example operation of the handheld cable puller 100. In the example operation, an electrical panel 602 is coupled to a first open end of a conduit 604 and a second open end of the conduit 604 is coupled to a junction box 606. In at least one embodiment, the conduit 604 is electrical metallic tubing (EMT) conduit. In other embodiments, the conduit 604 may PVC conduit. In still other embodiments, the conduit 604 may be any type of raceway such as conduit, tubing, or a junction box. In the example operation, it is desired to pull one or more cables (or wires) through the conduit 604 from the junction box 606 to the electrical panel 602 while leaving a desired length of cable or cables, or makeup, exposed at the electrical panel 602 to allow for termination of the cables. In an initial step of operation, the pulling cable 134 is unwound from the cable drum 118 of the handheld cable puller 100 and extended into the end of conduit at the electrical panel 602 through the conduit 604 and exiting at the junction box 606. In one embodiment, the pulling cable 134 may be unwound from the cable drum 118 by running of the motor 116 in the unwinding direction of rotation. In another embodiment, the pulling cable 134 may be unwound from the cable drum 118 by disengagement of the motor 116 from the cable drum 118 using the disengagement mechanism 168 wherein the drum 118 will “freewheel” and manual pulling of the pulling cable 134 to unwind the pulling cable 134 from the cable drum 118. In still other embodiments, the pulling cable 135 may be attached to a jetline that has been previously extended through the conduit 604. A number of procedures exist for extending a pulling cable or jetline through a length of conduit as would be understood to those having ordinary skill in the art. For example, U.S. Pat. No. 3,793,732 describes a process of propelling a length of cable through a conduit via air pressure which patent is incorporated herein by reference in its entirety. In at least one embodiment, the pulling cable 134 may be coated with a lubricant prior to being fed through the conduit 604 in order to facilitate pulling of the pulling cable 134 therethrough. Prior to the beginning of extending the pulling cable through the conduit 604, the line length meter 156 may be reset by the user. After the pulling cable 134 is extended through the conduit 604, the user may read the line length meter 156 to determine the length of pulling cable 134 that has been extended through the conduit 604. This allows the user to determine the length of cable that will be necessary to fully extend the cable through the conduit from the junction box 606 to the electrical panel 602 during the pulling operation.

After feeding of the pulling cable 134 through the length of conduit from the electrical panel 602 to the junction box 606, the pulling cable is fed through a rotating flexible feed end 614 and out of the face of the junction box 606. The rotating flexible feed end 614 includes a roller that facilitates pulling of the pulling cable 134 and attached cables into the open end of the conduit coupled to the junction box 606. The pulling cable 134 is then fed through a flexible raceway 608 to a funnel system 610. The pulling cable 134 is then coupled or attached to one or more cables (or wires) wound on individual wire spools 616 of a wire dolly 612. In one embodiment, the one or more pulled cables are coupled to the pulling cable 134 using a cable head (see FIG. 12). The wire spools 616 are mounted on a wire dolly frame 618. To facilitate movement of the wire dolly 612, the wire dolly frame 618 may be provided with fixed casters 620 on one end and rotating casters 622 on an opposite end. The wire dolly 612 may be further provided with a brake 624 configured to, upon engagement, lock the rotating caster 622 into a fixed position. The flexible raceway 608 and funnel system 610 functions to gather multiple cables together as they are pulled into the conduit 604 by the pulling cable 134.

During the wire pulling operation, the handheld cable puller 100 is held by a user 624 via one or more of the first handle portion 106 and the second handle portion 144, and the pulling head 160 is placed against the open end of the conduit 604 terminating at the electrical panel 602. The user 624 then activates the motor of the handheld cable puller 100 in a reverse direction to wind the pulling cable 134 around the cable drum 118. As the pulling cable 134 is wound around the cable drum 118, the guide shaft hole 133 and attached guide portion 132 of the cable winding guide 126 oscillates in a left and right direction along the cable guide shaft 128. As a result, the pulling cable 134 is wound evenly upon the cable drum 118. In various embodiments, the frequency of oscillation of the guide shaft hole 133 and guide portion 132 of the cable winding guide 126 relative to rotation of the cable drum 118 may be varied by changing the respective gears ratios or by modifying the pitch of the cross-cut channels 130. During the winding of the pulling cable 134 around the cable drum 118, the cables from the wire dolly 612 coupled to the pulling cable 134 are pulled through the conduit 604. When the end of the pulling cable 134 coupled to the wires reaches the handheld cable puller 100, the user may deactivate the motor 116, leaving a length of exposed wire equal to the length the attachment arm 114, the pulling arm 158 and the one or more extension bar(s) 400, if used. By resting the pulling head 160 against the end of the conduit 604, substantially all the forces exerted during the pulling operation are transferred to the pulling head 160 instead of the pulling arm 158 or the handheld cable puller 100. Accordingly, forces imparted to the user 624 during the pulling operation are greatly minimized.

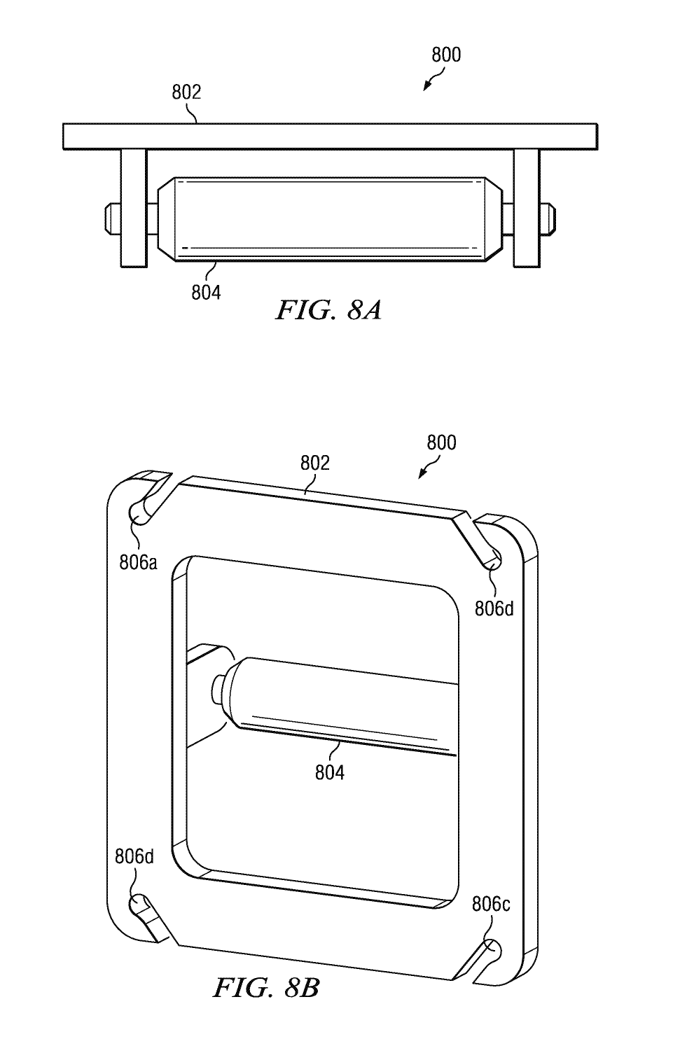

In an alternative embodiment, the rotating flexible feed end 614 may be replaced by a box roller 800 as will be further described with respect to FIG. 8. In still other embodiments, a rotating flexible feed end and box roller 800 may be omitted. After the attached cables are pulled from the end of the conduit 604 coupled to the electrical panel 602 and reach the handheld cable puller 100, the user may stop the motor 116 by releasing the finger control switch 146. In other embodiments, the handheld cable puller 100 may be configured to stop automatically upon the conclusion of the pulling operation. As a result of the pulling operation, a length of cable approximately equal to the length of the attachment arm 114 and the pulling arm 158 is exposed and may be terminated at the electrical panel 602 by the user, an electrician, or another worker. Similarly, the opposing end of the cable may be terminated at the junction box 606. Although the embodiment illustrated in FIG. 6 shows an electrical panel 602 coupled to a junction box 604 via a length of conduit 604, it should be understood that the principles of various embodiments of the handheld cable puller 100 may be used in any application in which it is desired to pull one or more cables or wires through a conduit.

With reference to FIG. 6, the general operation of utilizing the tool will be described. The operator of the tool when desiring to pull wire through the raceway or conduit will access the jetline that hangs out of the raceway or conduit. This is tied onto the end of the cable. When tying this on the end of the cable, the counter is reset to 0. However, when the extension is disposed on the tool, there will be a certain amount of “make up” accounted for. This is for the purpose of insuring that there is a certain length of wire that extends from the opening to the conduit after the pulling thereof. Thus, the counter is set to 0 and then the cable extracted from the spool with the clutch disengaged to allow the spool to be free spinning such that the counter will have a preset amount of line associated therewith. This will be substantially equal to the length of the extension when the end butts the opening to the conduit.

The cable end is then attached to the jetline and the jetline pulled back through the conduit or raceway. Some type of communication will be effected between the tool operator and the individual at the other end of the conduit that feeds the wire into the conduit. When the cable appears to the feeder, the tool operator will communicate the counter value, indicating the length of wire required to be pulled back through the conduit. It may be that the tool operator reads a value of, for example, 288 feet, which includes a 2 foot make up section. However, it may be that the feeder at the other end has pulled out 6 feet of cable such that the length is actually 282 feet. This is of no importance. It is just important that the feeder has at least 282 feet worth of wire that can be pulled through the conduit. With knowledge of the length of cable reeled out from the spool, the tool operator and the feeder have an idea of how much wire must be on the wire spool at the feeder end of the conduit in order to ensure that a sufficient amount of wire is available. Also, it is possible to use a spool that is less than a full spool, i.e., a partial spool, from which to provide wire. However, it is important not to use a partial spool that is less than the length of the conduit.

Once the wire is attached to the cable at the feeder end, the tool operator will be so informed and will then engage the spool with the clutch and then place the tool in the rewind mode. In this mode, the end of the tool is butted against the opening to the raceway such that all of the force associated with pulling the wire through the conduit will be borne by the tool itself and not by the tool operator. All the tool operator has to do is hold the tool at the appropriate height. If the tool has a fixed angle on the end, i.e., 90°, this may require the tool operator to hold the tool at the level of the conduit opening. This could be a fixed angle or a variable angle. Additionally, if the angle is fixed relative to the tool and always points downward, this will require the tool to be held upside down when pulling from a top opening and right side up when pulling from a downward extending conduit or sideways if the conduit were extended left or right. This is why the extension can be rotated in 90° segments to account for upwards, downwards, left or right orientation. This facilitates easier placement of the tool end.

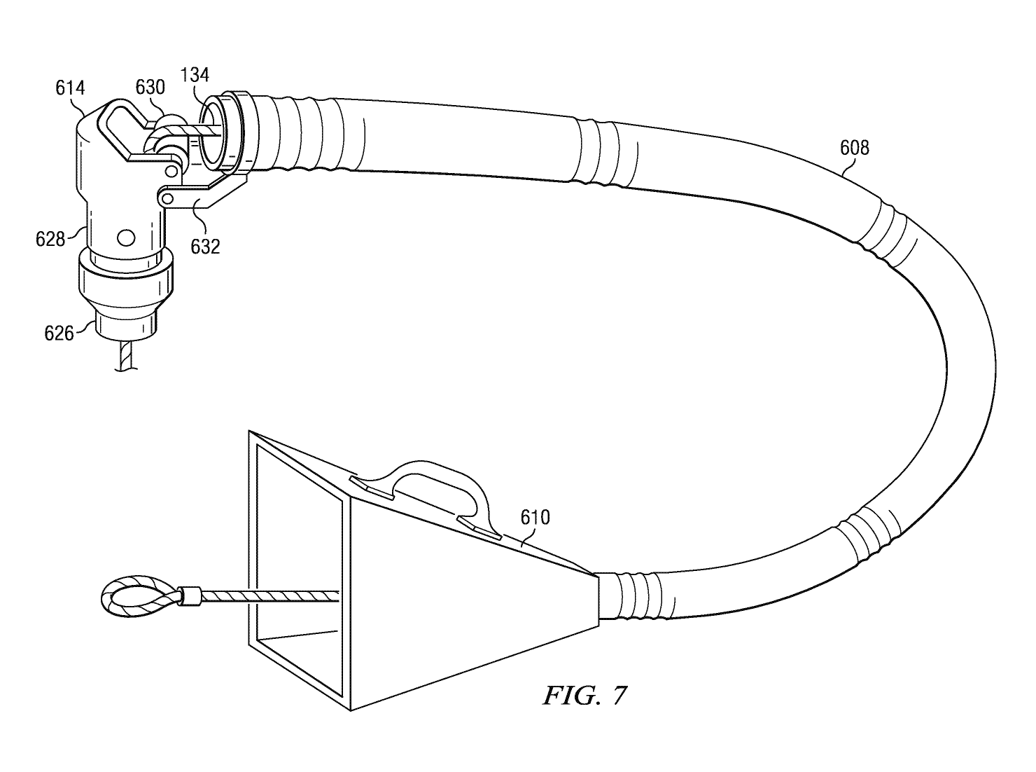

FIG. 7 illustrates a perspective view of an embodiment of the funnel system 610, raceway 608, and the rotating flexible feed end 614 of FIG. 6. The funnel system 610 is of a funnel shape having a relatively large cross-sectional opening on one end with decreasing cross-section to the other end coupled to the flexible raceway 608. In the illustrated embodiment, the funnel system 610 has a rectangular cross-section, but it should be understood that in other embodiments other cross-sections may be used. For example, in one embodiment, the funnel system 610 may have a circular cross-section. In at least one embodiment, the funnel system 610 may be provided with a handle to facilitate carrying of the funnel system 610 by a user. In a particular embodiment, the funnel system 610 may be affixed to the wire dolly frame 618 to stabilize the funnel system 610 during the pulling operation.

The rotating flexible feed end 614 includes a cup 626, which is adapted to be coupled to an end of the conduit 604. The rotating flexible feed end 614 further includes an elbow portion 628 having a roller 630 rotatably supported thereon. The rotating flexible feed end 614 further includes a bracket 632 hingedly coupled to the elbow portion 628 and having a end adapted to be coupled to the flexible raceway 608. During a pulling operation, the pulling cable 134 passes through from the raceway 608, through the elbow portion 628, into the cup 626 and further into the conduit 604. In a particular embodiment, the cup 626 allows rotation of the rotating flexible feed end 614 about the end of the conduit 604.

FIGS. 8A-8B illustrate an embodiment of the box roller 800 of FIG. 6. FIG. 8A illustrates a side view of the embodiment of the box roller 800 of FIG. 6. FIG. 8B illustrates a bottom view of the embodiment of the box roller 800 of FIG. 6. In various embodiments, the box roller 800 may be used as an alternative to the rotating flexible feed end 614 of FIG. 7B. The box roller 800 includes a box frame 802 and a roller 804 rotatably supported thereon. The box frame 802 further includes one or more screw slots 806a-806d configured to facilitate attachment, such as by screwing or bolting, of them box roller 800 to the face of the junction box 606. In a particular embodiment, the roller 804 is positioned such that when the box roller 800 is fastened to the junction box 606, the top of the roller 804 substantially lines up with the center of the conduit end of the conduit 604. The pulling cable 134 may then be fed over the roller 804 into the conduit 604.

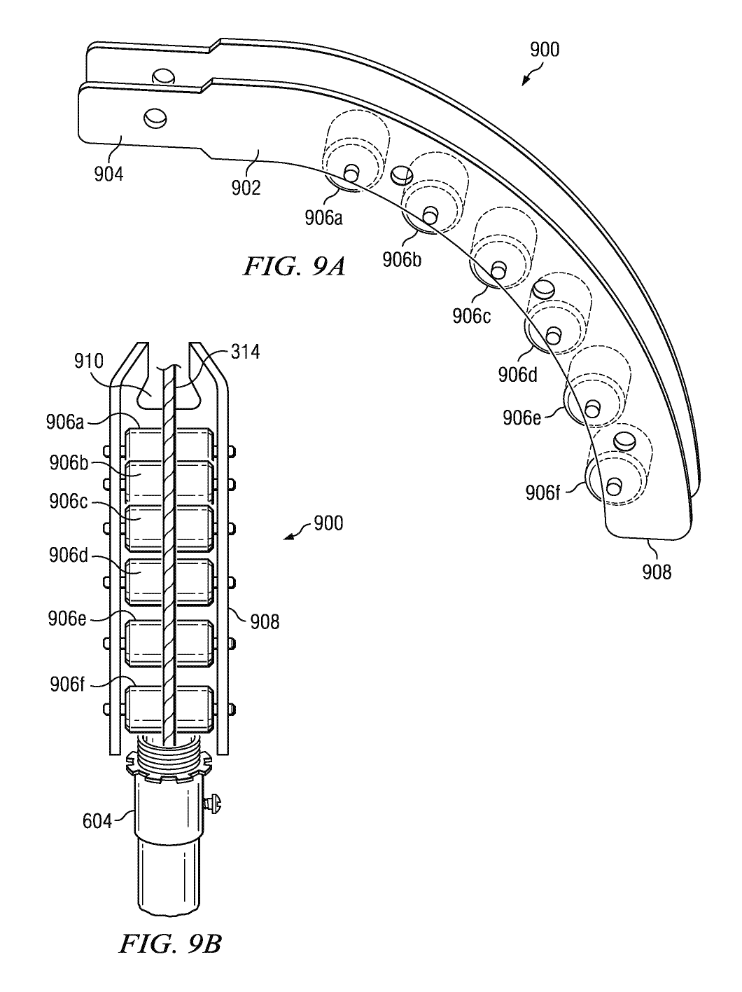

FIGS. 9A & 9B illustrate an alternative embodiment of a pulling arm 900. FIG. 9A illustrates a side view of the pulling arm 900. FIG. 9B illustrates a front perspective view of a pulling arm 900. In various embodiments, the pulling arm 900 may be used in place of the pulling arm 158 of FIG. 1A. The pulling arm 900 includes a pulling arm frame 902 having a substantially arcuate profile. The pulling arm 900 includes a male end 904 configured to be coupled to either the attachment arm 114 of the handheld cable puller 100 or a female end 406 of an extension bar 400. The pulling arm frame 902 includes a rollers 906a-906f rotatably supported on a bottom portion of the arcuate-shaped portion of the pulling arm frame 902. The pulling arm 900 includes a pulling head end 908 at an end of the pulling arm 900 opposite to that of the male end 904. The pulling head end 908 is adapted to be placed against or proximate to the end of a conduit 604. The pulling arm 900 further includes a cable channel 910 through which the pulling cable 314 is fed. The pulling cable 314 is further fed over the rollers 906a-906f and through the conduit 604. In at least one embodiment, the arcuate curve from the male end 904 to the pulling head end 908 forms a substantially 90 degree angle. In a particular embodiment, the rollers 906a-906f are disposed at substantially 15 degree angles from each other along the arcuate curve. During an example use of the pulling arm 900, the pulling head end 908 is placed against an end of the conduit 604.

FIGS. 10A-10B illustrate another alternative embodiment of a pulling arm 1000. FIG. 10A illustrates a side perspective view of the pulling arm 1000. FIG. 10B illustrates a front perspective view of the pulling arm 1000. The pulling arm 1000 includes a collar 1002 hingedly coupled to a cable channel 1004 at a substantially 90 degree angle. The pulling arm 100 further includes a roller 1006 rotatably supported within the cable channel 1004. The collar 1002 is adapted to be coupled to an end of a conduit 604. In a particular embodiment, the collar 1002 is adapted to be coupled an electrical metallic tubing (EMT) connector 1008 of a conduit 604. The cable channel 1004 further includes a male end 1010 adapted to be coupled to the attachment arm 114 of the cable puller 100 or a female end 406 of the extension bar 400. During a pulling operation, the collar 1002 is coupled to the EMT connector 1008 and a pulling cable 134 is fed through the cable channel 1004, over the roller 1006, through the collar 1002, and into the conduit 604.

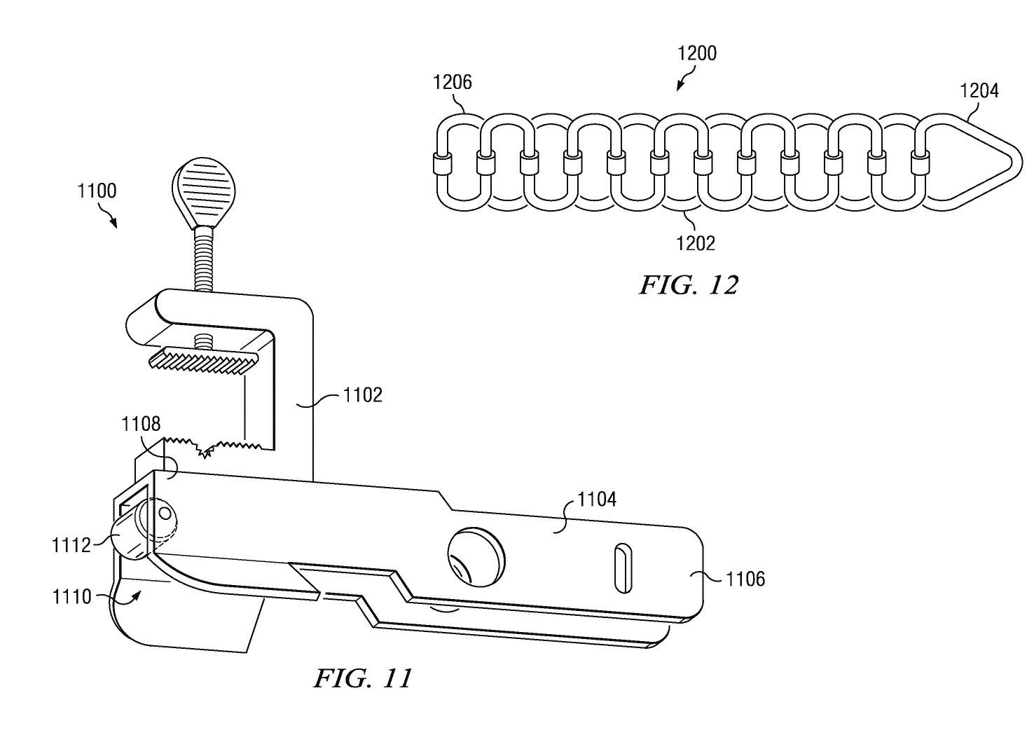

FIG. 11 illustrates another embodiment of a pulling arm 1100. The pulling arm 1100 includes a clamp 1102 coupled to a frame 1104. The frame 1104 includes a male attachment end 1106 adapted to be coupled to the attachment arm 114 of the cable puller 100 or a female end 405 of the extension bar 400. The frame 1104 further includes a channel end 1108 having a cable channel 1110. The pulling arm 1100 further includes a roller 1112 rotatably supported within the cable channel 1110. During a pulling operation, the clamp 1102 is coupled to an electrical box, such as a junction box or electrical panel, with the cable channel 1110 located proximate to an end of a conduit 604. The pulling cable 134 is fed through the cable channel 1110, over the roller 1112, and into the conduit 604.

FIG. 12 illustrates an embodiment of a cable head 1200 for attachment of cables or wires to the pulling cable 134. The cable head 1200 includes a conductor loop portion 1202 and a pulling cable attachment portion 1204. In a particular embodiment, the cable head 1200 is constructed of a loop of cable, such as aircraft cable. The conductor loop portion 1202 includes a plurality of loops 1206 through which the cables or wires to be pulled through the conduit 604 are secured. The pulling cable attachment portion 1204 includes a loop to which the pulling cable 134 is attached. During a pulling operation, the loops 1206 cause the cables to be tightly bound to the cable head 1200. The loops 1206 the cables to be staggered to provide of easier pulling around bends.

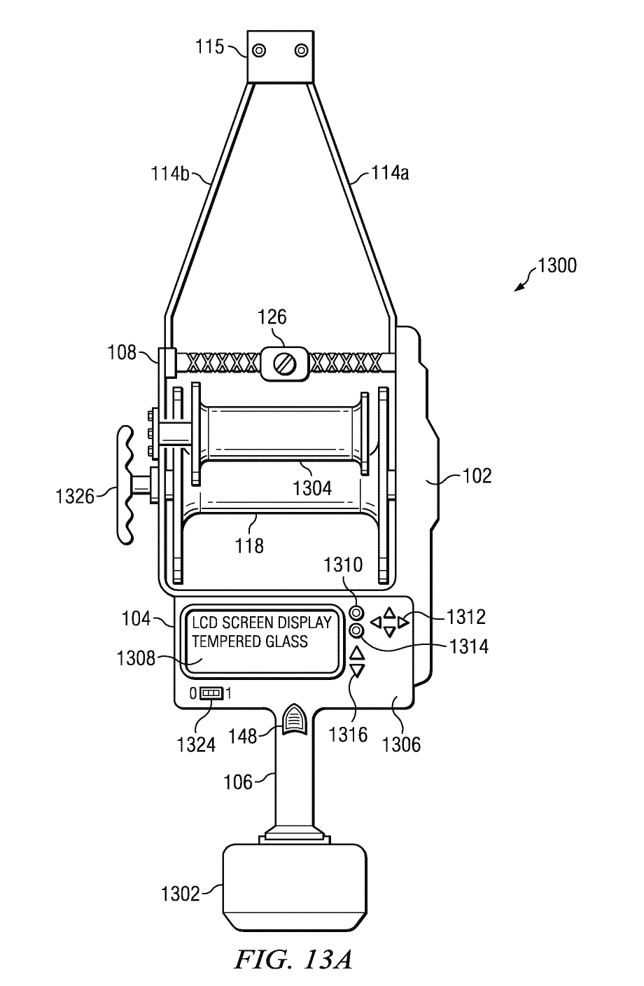

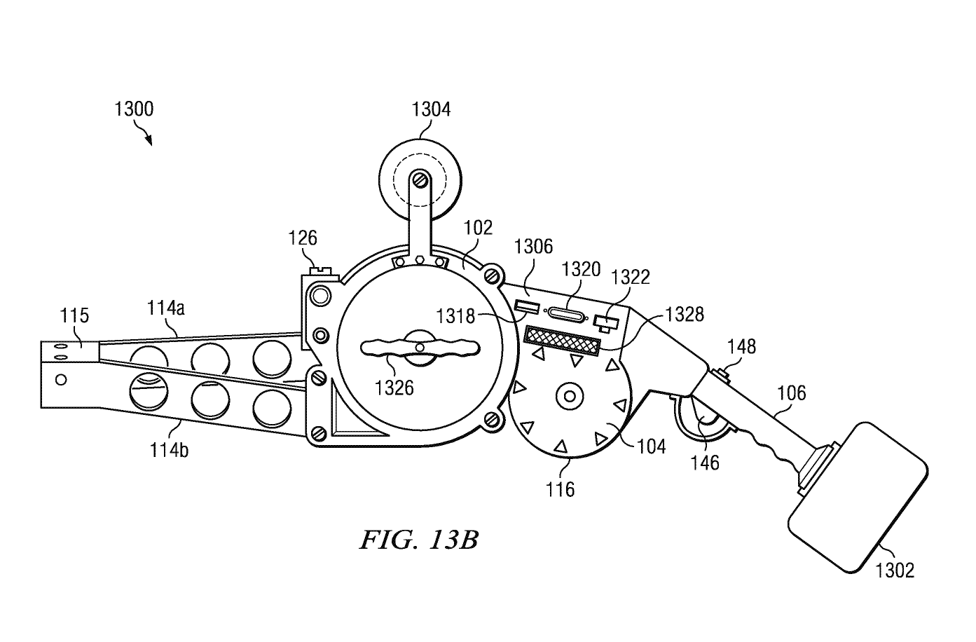

FIGS. 13A-13B illustrate an embodiment of a hand-held cable puller 1300 having a configurable maximum pulling force. FIG. 13A illustrates a top side view of the hand-held cable puller 1300. FIG. 13B illustrates a left-side view of the hand-held cable puller 1300. The hand-held cable puller 1300 is configurable to allow a user to preselect a maximum pulling force setting prior to pulling a cable that limits the pulling force of the hand-held cable puller 1300 to the cable manufacturer's specifications to prevent damage to the cable being installed. In various embodiments, the hand-held cable puller 1300 records data regarding all cable pulls including the pulling force, the actual cable length pulled, and the date and time of the cable pull operation. In various embodiments, the hand-held cable puller 1300 is configured to allow upload of blueprint data to memory of the hand-held cable puller 1300. The blueprint data includes a designation of a number of cable pulls that are part of a particular cable pulling job. The blueprints may include a job name and/or a job number and all cable specifications of the various cable pulls including estimated lengths of each cable pull, maximum allowed pulling force of each cable pull, designations of the cables used for each pull, and designations of cable types for each pull. This blueprint information may be preloaded ahead of the start of a job. After job completion in which all cable pulls have been made, data can be downloaded from the hand-held cable puller 1300 that may include the actual length of each cable pull as well as the maximum actual pulling force of each cable pull. The data may further include a date and time of each cable pull indicating the amount of time which was required for each cable pull. This downloaded information may be compared to the estimated values to determine if, for example, additional lengths of cable were needed greater than that estimated, or to determine whether a particular cable was pulled with a force beyond the maximum allowed by the cable manufacturer. The hand-held cable puller 1300 may be used to pull, for example, low voltage or signal cables in raceways or conduits by coiling up the jet lines or mule tape, ¼″ pulling rope, etc., which may be preinstalled in the raceways or conduits prior to the pulling operation. The hand-held cable puller 1300 is particularly suitable to pull high definition cable, coaxial cables, cat-5 cables, fiber optic cables, audiovisual cables, Belden cables, phone cable, security cable, fire alarm cable, networking cable, or voice over IP cables. However, it should be understood that the hand-held cable puller 1300 may be used to pull any suitable cable in which it is desired to limit the pulling force applied to the cable to meet cable manufacturer specifications.

The hand-held cable puller 1300 includes a drum housing 102 coupled to a motor housing 104 having a first handle portion 106. The hand-held cable puller 1300 further includes a first attachment arm 114A and a second attachment art 114B attached to a frame 108 at first ends of the attachment arms 114A, 114B. Second ends of the attachment arms 114A, 114B are coupled to an attachment end coupler 115. In various embodiments, pulling arms, as previously described herein may be attached to the attachment in coupler 115. The hand-held cable puller 1300 further includes a cable drum 118 to which a pulling cable may be attached as previously described herein. The hand-held cable puller 1300 includes a motor 116 coupled to the cable drum as previously described herein. The hand-held cable puller 1300 includes a cable winding guide 126 or level wind which facilitates winding and unwinding of the pulling cable around the cable drum 118 which operates as previously described. The first handle portion 106 includes a finger control switch 146 which provides for variable speed control of the hand-held cable puller 1300. The first handle portion 106 further includes a thumb safety switch 148 which is required to be pressed by a user during operation of the hand-held cable puller 1300 to provide for safe operation thereof.

The hand-held cable puller 1300 further includes a battery 1302 coupled to the first handle portion 106 to provide power to the various components of the hand-held cable puller 1300. In still other embodiments, the hand-held cable puller 1300 may be operated by a corded connection to a power source, such as a 120 volt AC power source. The hand-held cable puller 1300 includes a support handle 1304 coupled to the drum housing 102 which allows a user to grasp the support handle 1304 to provide additional stabilization of the hand-held cable puller 1300 during a pulling operation.

The hand-held cable puller 1300 includes an electronic control module 1306 to provide various control functions of the hand-held cable puller 1300 as will be further described. The electronic control module 1306 includes an LCD display 1308 to provide visual feedback to a user, a reset over current button 1310 allowing a user to reset the hand-held cable puller 1300 when a maximum pulling force has been exceeded, and menu control buttons 1312 that allow the user to navigate within the LCD display 1308. The electronic control module 1306 includes a selection button 1314 to allow a user to select a highlighted function within the LCD display 1308, and scroll buttons 1316 which allow a user to scroll to select a desired pulling force. The hand-held cable puller 1300 further includes a USB port 1318, a parallel port 1320 and/or a RJ45 port 1322 which may allow for uploading and downloading of data as well as setting parameters for the hand-held cable port 1300. It should be understood that in other embodiments, other methods of communicating with the hand-held cable puller 1300 may be used such as via a removable memory card or by wireless communication. The electronic control module 1306 may further include an on/off switch 1324 allowing a user to turn the electronic control module 1306 on or off as desired.

The hand-held cable puller 1300 further includes a drive clutch 1326 coupled to the cable drum 118. The drive clutch 1326, when pulled outward and rotated by a user, disengages the cable drum 118 from the coupling with the motor 116 and allows the drum to spin freely. The hand-held cable puller 1300 may further include a heat vent 1328 to allow exhausting of heat generated by the drive motor 116 and the electronic control module 1306.

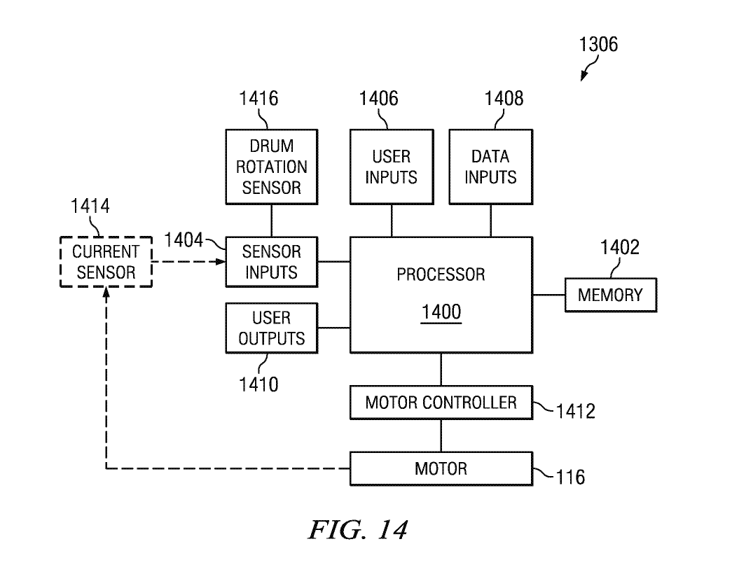

FIG. 14 illustrates a block diagram of the electronic control module 1306 of the hand-held cable puller 1300. The electronic control module 1306 includes a processor 1400 and a memory 1402 in communication with the processor 1400. In various embodiments, processor 1400 may include a CPU, a microprocessor or any other suitable processor. The memory 1402 may include one or more of RAM, ROM, flash memory, a hard drive, or any other suitable memory. In various embodiments, the memory 1402 stores software instructions and data such as blueprint data, user settings, and output data of a pulling operation. The electronic control module 1406 further includes sensor inputs 1404 in communication with the processor 1400. The sensor inputs 1404 provide sensor data to the processor 1400 which indicate the current pulling force on the pulling cable as well as the current length of the pulled cable. Electronic control module 1306 includes user inputs 1406 and data inputs 1408 in communication with the processor 1400 to provide inputs from a user, and input data such as blueprint data to the processor 1400 to be stored in the memory 1402. The electronic control module 1306 includes user outputs 1410 which provide user interface and feedback data to a user. In a particular embodiment, the user outputs 1410 are provided to the LCD display 1308. The electronic control module 1406 further includes a motor controller 1312 in communication with the processor 1400. The motor controller 1412 is in further communication with the motor 116. The motor controller 1410 under command of the processor 1400 controls the operation of the motor 116 during a pulling operation such as the direction and speed of the motor 116. In particular, the motor controller 114 regulates the motor 116 so that the pulling force exerted on the cable during a pulling operation does not exceed the maximum pulling force specified by the cable manufacturer.

In a particular embodiment, the electronic control module 1306 includes a current sensor 114 which is configured to receive a measure of the current supplied to the motor 116 and output the measured current to the sensor inputs 1404. By receiving a measure of the current of the motor 116, the processor 1400 may determine the torque produced by the motor 116 such as by using a look-up table stored in memory 1402 which maps current values to torque values or by performing a direct calculation of the torque based upon the measured current. The electronic control module 1306 may further include a drum rotation sensor 1316 which senses the rotation of the cable drum 118 and provides this data to the sensor inputs 1404. The processor 1400 may use the data obtained from the drum rotation sensor 1406 to calculate the current pulled cable length as well as determine the amount of the pulling cable which is currently wrapped on the cable drum 118. The processor 1400 may determined the amount of the pulling cable which is currently wrapped on the cable drum 118 by knowing an initial value of the amount of cable wrapped on the cable drum 118 at the beginning of the pulling operation and determining the amount of cable which has been pulled based upon the rotation of the cable drum 118. Using the current wire diameter, the amount of pulling cable left on the spool, and the current of the motor 116, the processor 1400 may calculate the current pulling force exerted on the cable being pulled through the conduit. If the current pulling force exceeds the manufacturer specified maximum pulling force, the processor 1400 instructs the motor controller 1412 to turn off the motor 116. The user may then take corrective action, such as removing the cable, and then resetting the hand-held cable puller 1300 to allow for further pulling operations. In an alternative embodiment, instead of using the drum rotation sensor 1416 to determine the amount of pulling cable on the cable drum 118, a light sensor may be used to detect the current amount of pulling cable wrapped on the cable drum 118.

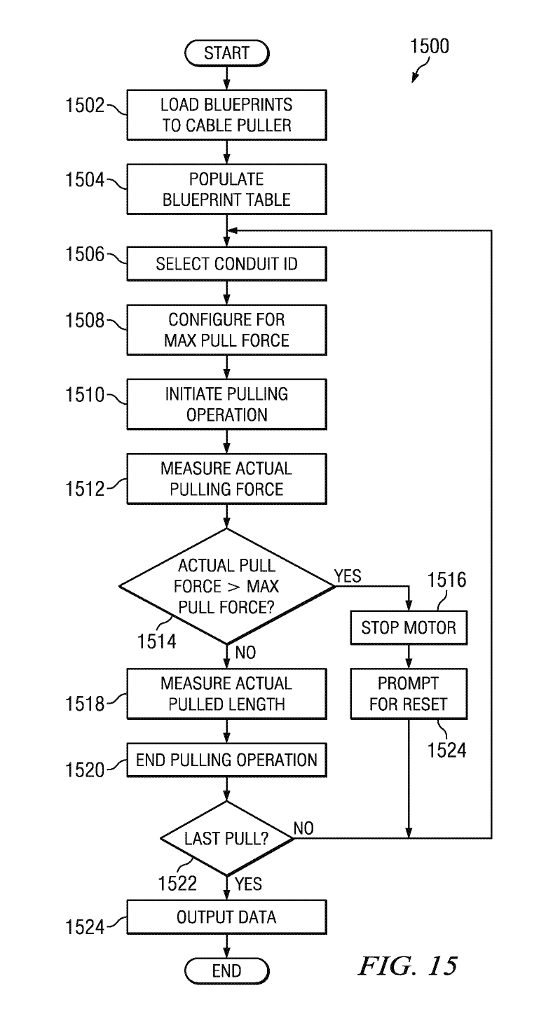

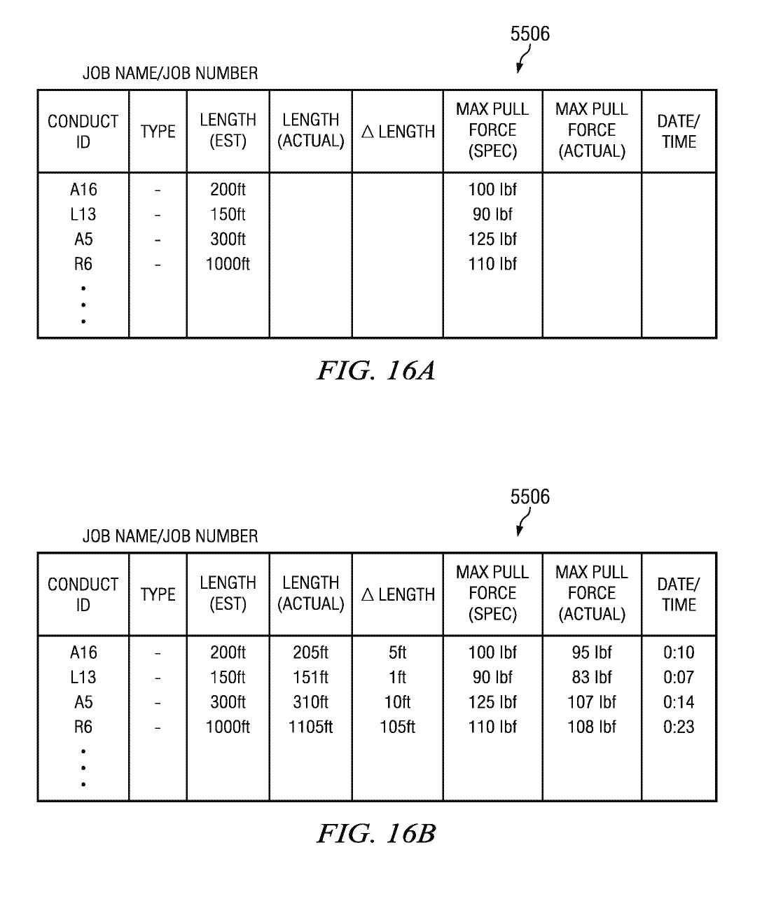

FIG. 15 illustrates an embodiment of a procedure 1500 for operation of the hand-held cable puller 1300. In step 1502 blueprints for a particular job are loaded into the cable puller 1300 through data inputs 1408, such as through the USB port 1318, the parallel port 1320, or the RJ 45 port 1322. In still other embodiments, the blueprints may be loaded through a memory card, through a wireless connection, entry by a user using the LCD display 104, or any other suitable data input method. The blueprint data may include a job name and/or job number, all cable specs for each conduit of the job, estimated lengths of each of the cables, maximum pulling forces specified by the manufacturer for each pulling cable, and a designation of the cable type. In step 1504, a blueprint table is populated within the memory 1402 of the hand-held cable puller 1300 corresponding to the blueprint data input into the hand-held cable puller 1300. FIG. 16A illustrates an example of a blueprint table for a particular job. In the blueprint table of FIG. 16A, each cable to be pulled through a particular conduit of the job is given a conduit ID. For each conduit ID, a cable type, an estimated length, and a maximum pulling force specified by the manufacturer is populated within the blueprint table at the time of loading into the memory 1402. In the example illustrated in FIG. 16A, the job is giving a job name/job number of “5506.” Conduit ID A16 is configured to an estimated length of 200 feet and a maximum pulling force specified by the manufacturer of 100 lbf. Conduit ID L13 is given an estimated length of 150 feet and a manufacturer specified maximum pulling force of 90 lbf. Conduit ID AS is designated with an estimated length of 300 feet and a manufacturer specified maximum pulling force of 125 lbf, and conduit ID R6 is provided with an estimated length of 1000 feet and a manufacturer specified maximum pulling force of 110 lbf.

Returning now to FIG. 15, in step 1506 a user selects the conduit ID for the current cable pull that the user desires to perform. In step 1508, the processor 1400 configures the motor controller 1412 for a maximum pull force to that designated by the selected conduit ID. In step 1510, the user initiates pulling operation of the current cable pull. In a particular embodiment, the user initiates the pulling operation by squeezing the finger control switch 146 to initiate the motor 116 to wind the pulling cable about the cable drum 118. In step 1512, the actual pulling force exerted on the cable to be pulled is measured during the pulling operation. In step 1514 is determined whether the actual pulling force has exceeded the maximum pulling force designated for the cable associated with the conduit ID currently selected. If it is determined that the actual pulling force has not exceeded the maximum pulling force, the procedure continues to step 1518 in which the actual pulled length of the cable is measured during pulling operation. In a particular embodiment, the actual pulled length may be determined from the sensed rotation of the cable drum 118. Once the cable to be pulled is pulled completely through the conduit, the pulling operation is ended in step 1520. In a particular embodiment, the pulling operation is ended by the user releasing the finger switch 146. In step 1522 it is determined whether the last pull of the job has been performed. If the last pull of the job has not been performed, the procedure 1500 returns to step 1506 in which the user may select the next conduit ID associated with the next cable to be pulled and the procedure 1500 continues as described before. If in step 1522 it is determined that the last pull of the job has been performed, the procedure 1500 continues to step 1524 in which data of the pull is outputted. The output data includes all recorded data associated with the job. Referring now to FIG. 16B, in an example embodiment, the output data further includes an actual length of the cable pulled for each job, a calculation of the difference in length between the actual length and the estimated length for each conduit ID, and the actual maximum pulling force for each conduit ID. The output data may further include the date and time at which each cable pull of the job was performed so that a total time required to perform each cable pull is indicated. As an alternative to displaying only the actual maximum pulling force, in other embodiments, a graph of the pulling forces exerted on each cable during the entire pulling operation may be displayed. In one embodiment, the data output may be provided to the LCD display 1308. In still other embodiments, the output data may be stored in the memory 1402 and retrieved at a later time by downloading the data through one or more of the USB port 1318, the parallel port 1320, the RJ45 port 1322, a memory card, a wireless connection or any other suitable device. In a particular embodiment, the output data may be encrypted and stored within the memory 1402 such that it can only by downloaded and view by authorized personnel.

FIG. 16B illustrates an example of the blueprint table stored within the memory 1402 after completion of the pulling operation. As illustrated in FIG. 16B, the actual length of the cable pull of conduit ID A16 is 205 feet using a difference in length between the actual length and the estimated length of 5 feet. The actual maximum pull force of the cable pull of conduit ID A16 is 95 lbf and the pulling operation took 10 minutes. The actual length for conduit ID L13 is 151 feet giving a difference in length between the actual length and estimated length of 1 foot, and the actual maximum pull force was 83 lbf. The pulling operation of conduit ID L13 took 7 minutes. The actual length of the pull associated with conduit ID A5 was 310 feet giving a difference between the actual length and estimated length of 10 feet. The actual maximum pull force of the cable pull associated with conduit ID A5 was 107 lbf and the pulling operation took 14 minutes. The actual length of the cable pull for conduit ID R6 was 1105 feet giving a difference in length between the actual length and estimated length of 105 feet. The actual maximum pull force of the conduit ID R6 cable pull was 108 lbf and the pulling operation took 23 minutes. Using the difference in length between the actual cable length and the estimated cable pulling length, the contractor associated with the cable pulling operation may seek additional compensation for the additional cable required due to the differences between the actual cable length and estimated cable length.

Returning again to FIG. 15 if during step 1514 it is determined that the actual pulling force exceeds the maximum force, the procedure continues to step 1516 in which the motor controller 1412 is instructed by the processor 1400 to stop operation of the motor 116. In step 1524, the user may be prompted to reset the hand-held cable puller 1300 and to continue operation by returning to step 1506 in which the user may select a new conduit ID. The user may further attempt to identify the problem associated with the conduit ID which caused the actual pulling force to exceed the maximum pulling force specified by the manufacturer. For example, a conduit through which the cable is being pulled may have been constructed such that the number of bends within the conduit exceeds that which are allowed. The user may then either try the pull again for that particular conduit once the problem has been resolved or skip the problem conduit and proceed to pull another conduit until such time that the problem conduit has been corrected.

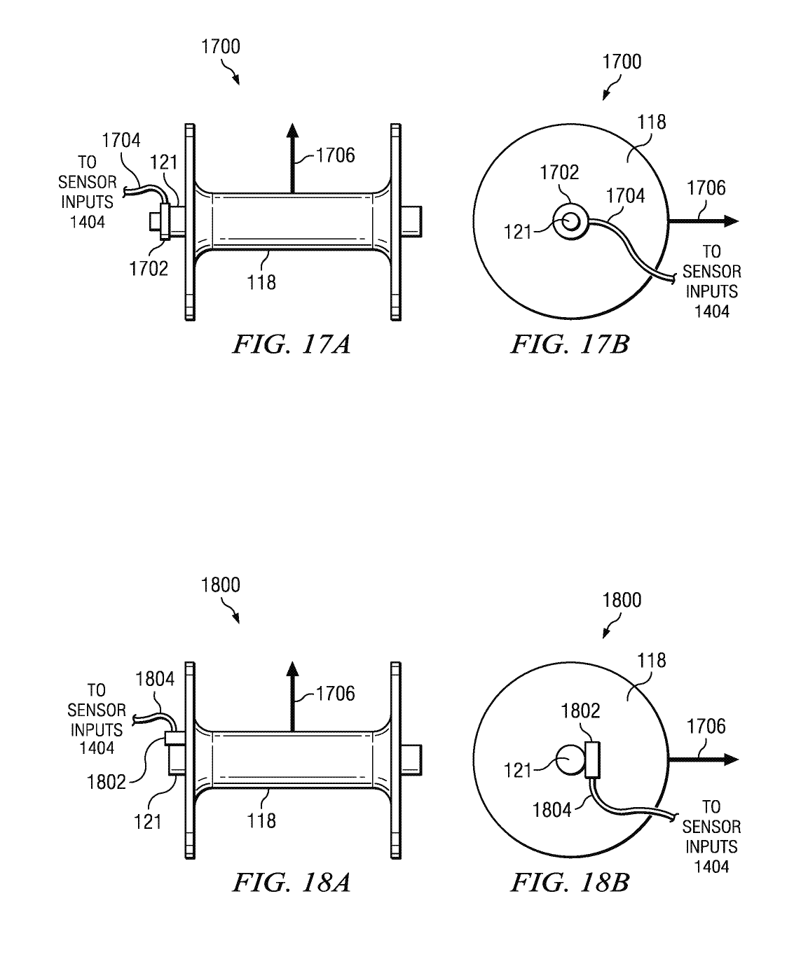

FIGS. 17A-17B illustrate an alternative embodiment of a pulling force measurement arrangement 1700 of the hand-held cable puller 1300. FIG. 17A illustrates a top view of the pulling force measurement arrangement 1700, and FIG. 17B illustrates a right side view of the pulling force measurement arrangement 1700. In the arrangement illustrated in FIGS. 17A-17B, the torque value output by the motor is directly measured instead of being determined by a measurement of motor current in order to determine the value of a pulling force 1706. In the pulling force measurement arrangement 1700, a torque sensor 1702 is coupled to the drum shaft 121 of the cable drum 118. The torque sensor 1702 further includes a torque sensor output 1704 in communication with the sensor input 1404 of FIG. 14. During a pulling operation, the torque sensor 1702 provides a direct measure of torque provided by the motor 116 to the processor 1400, and the processor 1400 uses this torque measurement along with the cable diameter and the amount of cable wound on the cable drum 118 to determine the pulling force 1706 exerted on the pulled cable.

FIGS. 18A-18B illustrate another embodiment of a pulling force measurement arrangement 1800 for the hand-held cable puller 1300. FIG. 18A illustrates a top view of the pulling force measurement arrangement 1800 and FIG. 18B illustrates a right-side view of the pulling force measurement arrangement 1800. In the embodiment of FIGS. 18A-18B, a load cell 1802 is coupled to the drum shaft 121 of the cable drum 118. A load cell is a transducer that is used convert a force into an electrical signal. In a typical arrangement of a load cell, the force is sensed by a strain gauge. The strain gauge measures the mechanical deformation of the strain gauge and outputs as electrical signal representative of the deformation. This is because the strain on the load cell changes the effective electrical resistance of a load cell wire which in turn various the output voltage. The output of the load cell is provided as a measurement of the force exerted on the load cell. In the particular embodiment illustrated in FIGS. 18A-18B, the load cell 1802 includes a load cell output 1804 which is in communication with sensor inputs 1404 of FIG. 14. The processor 1400 uses the load cell output, the cable diameter, and the amount of cable wound on the cable drum 118 to determine the pulling force 1706 exerted on the pulled cable.

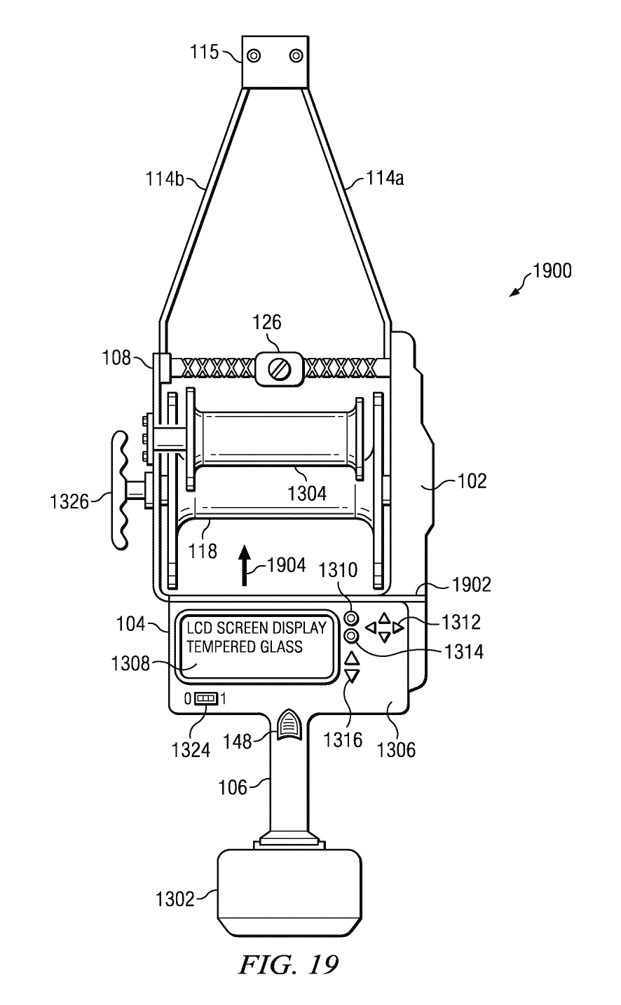

FIG. 19 illustrates an embodiment of a hand-held cable puller 1900 having a rear mounted load cell to measure pulling force exerted on a pulled cable. In the embodiment illustrated in FIG. 19, a load cell 1902 is mounted between the drum housing 102 and the motor housing 104. In the embodiment illustrated in FIG. 19, the drum housing 102 and cable drum 118 are mounted on a floating frame such that force exerted on the cable drum 118 caused by a pulled cable causes force upon the cable drum. The load cell 1902 measures a stretching force 1904 exerted on the load cell 1902, and the output of the load cell 1902 is provided to the sensor input 1404 of FIG. 14. The processor 1400 uses the load cell output 1904 to compute the pulling force exerted on the cable being pulled during a pulling operation.

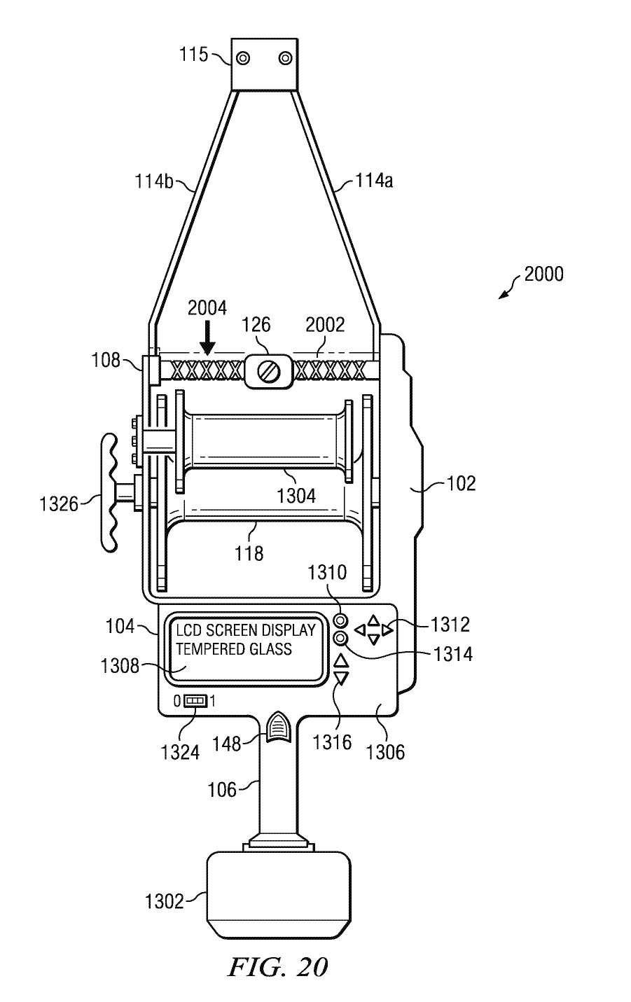

FIG. 20 illustrates still another embodiment of a hand-held cable puller 2000 having a frontally mounted load cell to measure pulling force exerted on a pull cable. The hand-held cable puller 2000 of FIG. 20 includes a load cell 2002 mounted between attachment arm 114A and 114B and in contact with the drum housing 102. The drum housing 102 and cable drum 118 are mounted on a floating frame such that the forces exerted on the pulling cable during a pulling operation upon the cable drum 118 are imparted as a compressive force 2004 upon the load cell 2002. The output of the load cell 2002 is provided to sensor inputs 1404 of FIG. 14. The processor 1400 determines the pull force exerted on the cable from the output of the load cell 2002. Although in the particular illustrated embodiment, the load cell 2002 is shown as mounted between attachment arm 114A and 114B and in contact with the drum housing 102, it should be understood that in other embodiments, the load cell 2002 may be mounted at any suitable location. In addition, although various embodiments are illustrated using current sensors, torque sensors, or load cells, it should be understood that in other embodiments any suitable method of measuring the pulling force exerted on a pulled cable may be used.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A handheld portable cable puller for pulling cable through a raceway comprising:
a housing;
a spool fixedly interfaced to the housing;
a length of pulling cable disposed on the spool for being played out from the spool and rewound on the spool;
a motive device for driving the spool to rewind the pulling cable on the spool;
an interface for abutting proximate to an end of the raceway to substantially absorb resistive forces from the pulling cable during rewinding;
a processor; and
a memory coupled to the processor;
wherein the processor is configured to receive data including a designation of a specified maximum pulling force associated with a particular cable, measure an actual pulling force during a pulling operation of the particular cable, stop the motive device if the measured actual pulling force exceeds the specified maximum pulling force.

2. The handheld portable cable puller of claim 1, wherein the housing further includes a user interface in communication with the processor.

3. The handheld portable cable puller of Clam 1, wherein the data further includes an estimated cable length associated with the particular cable, and wherein the processor is further configured to measure an actual cable length during the pulling operation.

4. The handheld portable cable puller of claim 3, wherein the processor is further configured to determine a difference between the measured actual cable length and the estimated cable length.

5. The handheld portable cable puller of claim 1 further comprising at least one data input for receiving the data.

6. The handheld portable cable puller of claim 1 further comprising at least one sensor input for receiving sensor data representative of the actual pulling force.

7. The handheld portable cable puller of claim 6, wherein the at least one sensor includes a current sensor configured to measure a current associated with the motive device.

8. The handheld portable cable puller of claim 6, wherein the at least one sensor includes a torque sensor coupled to a shaft of the spool.

9. The handheld portable cable puller of claim 6, wherein the at least one sensor includes a load cell coupled to the shaft of the spool.

10. The handheld portable cable puller of claim 6, wherein the at least one sensor includes a load cell coupled to the housing.
